(19) United States
(12) Patent Application Publication
(10) Pub. No.: US 2026/0192875 A1
(43) Pub. Date: Jul. 9, 2026

(54) ADJUSTABLE SEATPOST ASSEMBLY

(71) Applicant: Raphael Schlanger, Wilton, CT (US)

(72) Inventor: Raphael Schlanger, Wilton, CT (US)

(21) Appl. No.: 19/557,226

(22) Filed: Mar. 5, 2026

Related U.S. Application Data
(63) Continuation-in-part of application No. 18/941,166, filed on Nov. 8, 2024.
(60) Provisional application No. 63/601,258, filed on Nov. 21, 2023.
(60) Provisional application No. 63/784,140, filed on Apr. 6, 2025.

(51) Int. Cl. B62J 1/06

(52) U.S. Cl. CPC B62J 1/06

(57) ABSTRACT

A seatpost assembly having: a first seatpost portion and a second seatpost portion, where the second seatpost portion is axially displaceable relative to the first seatpost portion in retracting and extending directions and is configured to include a seating surface; a motive force transmitted by a control rod to drive the axial displacement in at least one of the extending and retracting directions. The motive force is actuated remotely from the seatpost assembly.

### CROSS-REFERENCE TO RELATED APPLICATIONS

This application claims priority of U.S. Provisional Patent Application 63/784,140, filed Apr. 6, 2025, currently pending;

This application is also a Continuation-In-Part of U.S. patent application Ser. No. 18/941,166, filed Nov. 8, 2024, which is currently pending;

U.S. patent application Ser. No. 18/941,166, claims priority of Provisional Patent Application Ser. No. 63/601,258, filed Nov. 21, 2023, currently expired.

### BACKGROUND

### (1) Field of the Invention

The present invention relates to an improved telescopic assembly, in particular to a telescopic seatpost assembly for supporting a seating surface, particularly applicable to supporting the seat of a vehicle, such as a bicycle.

### (2) Description of the Related Art

Heretofore, the vast majority of bicycle seatposts have been of a rigid fixed-height configuration, where the seatpost is clamped to the frame at a given position and the height of the seat is not quickly and easily adjusted. However, more recently, height-adjustable seatposts, commonly called “dropper” seatposts, have been introduced to the market. These dropper seatposts are particularly popular in mountain bike applications where the seat must be quickly lowered or retracted to allow the rider additional clearance for riding over obstacles or steep terrain.

These dropper seatposts commonly employ two telescoping seatpost elements, comprising an inner member and an outer member, and a locking mechanism. The locking mechanism is functional to selectively lock and selectively release the axial displacement between these two elements-preventing telescopic displacement when locked and permitting telescopic displacement when released—to allow the seatpost to be telescopically adjusted to the desired height. With the locking mechanism normally locked, when the user wants to lower the seat height, he/she releases the locking mechanism and physically sits on the seat, using his/her weight to provide the motive force against the seat, pushing it down to the desired height, and thereby displacing the inner member to retract relative the outer seatpost element. This retracting displacement pushes against a mechanical or gas spring, thereby storing more energy in the spring. The user then releases and activates the locking mechanism to lock/restrict further displacement and maintain the desired seat height. Similarly, when the user wants to raise the seat height, he/she releases the locking mechanism and the stored energy in the spring serves to extend the inner member and raise the seat. During this raising, the user may use his/her buttocks to press against the seat and restrict this elevation to the desired height. The user then re-activates the locking mechanism to maintain the new seat height setting.

Further, the motive force to raise the seat is provided solely by the stored energy of its return spring, which continues to provide its motive force irrespective of the height of the seat and/or of the activation of the locking mechanism. Thus, the motive force is completely divorced from the control of the seat height. In other words, the user manipulates the locking mechanism, which serves only as a switch between releasing and locking the axial displacement of the internal member. The locking mechanism does nothing to retract or extend the seatpost assembly. Still further, the motive force provided by the spring is provided solely in the extending (i.e. raising) direction of axial displacement. This spring is housed within the seatpost itself and may be considered merely as an onboard energy storage device.

One significant shortcoming of this arrangement is that user's buttocks do not commonly have the dexterity to provide fine and precise control of the seat height. Additionally, in bicycle applications, the user is pedaling the bicycle while also adjusting the seat height, which further impairs the user's dexterity to provide fine and precise control of the seat height. In practice, the act of adjusting the seat height is quite awkward and frustrating, especially when attempting to select a seat height that is lower than the uppermost limit of the seatpost's telescopic displacement. It is even more awkward when attempting to select a seat height that is midway between the upper and lower limit of this telescopic displacement. This is further exacerbated while riding, and even further exacerbated while pedaling. In fact, users will commonly cease pedaling while attempting to adjust their seat height, thus detracting from the user's speed and control while riding.

Further, there is also no feedback to the user of the exact seat height setting or dimension. This makes it even more difficult to provide an accurate determination of the actual seat height as the user is trying to adjust it. As such, it is virtually impossible to repeatably adjust a conventional dropper seatpost to a specific seat height midway between the upper and lower limit of this telescopic displacement. The user must first sit on the seat and “test” the seat height by “feel” while riding and then attempt to further adjust as necessary. This process is clumsy and tedious and may need to be repeated multiple times to achieve the desired height, further interrupting the rider's pedaling. Furthermore, this “test” is not an accurate or absolute method of determining seat height and the user may find he/she needs further height adjustment at a later time.

An alternative to the conventional dropper post is outlined in U.S. Pat. No. 11,661,130 which relies on an electric motor to drive a lead screw to adjust the telescopic displacement and the seat height. The motor provides motive force in a rotary direction to drive a lead screw assembly to translate the rotary force into the linear longitudinal travel required to actuate the telescopic displacement. The lead screw assembly adds friction to the actuation of the seatpost as well as adding weight and cost. Furthermore, the electric motor requires an electric power source, most likely a battery mounted to the bicycle outside the seatpost assembly. Such a battery has the undesirable fault of adding weight to the bicycle. In this application, it is also understood that such a motor will draw a significant current to deplete the battery's stored energy, which requires a larger motor and a larger battery, further adding to the weight of the bicycle. Additionally, the user commonly requires very fast and “quick” seat height adjustment, which further increases the current requirement of the motor. Still further, batteries may lose their charge, which requires diligence on the part of the user to ensure that the proper charge is always maintained. And, of course, if the battery inadvertently loses its charge, the seat height adjustment will not operate.

Another alternative to the conventional dropper post is outlined in International Patent Application No. WO_2025174970 A1, which relies on two control cables to actuate the seatpost assembly. Both control cables serve to actuate the seatpost assembly only in tension. A conventional dropper seatpost requires only a single control cable and this requirement of two cables highly undesirable since both cables must now be threaded through the bicycle frame. This additional cable also negatively adds additional weight and complexity to the entire seatpost assembly system.

It is an objective of the present invention to provide a height-adjustable seatpost that is easy and efficient to operate and provides precise and predictable control of the seat height adjustment. It is a further objective of the present invention to provide accurate and repeatable control of the seat height as it is being adjusted. It is a still further objective of the present invention to provide a lightweight seatpost assembly. It is a still further objective of the present invention to provide an arrangement wherein the control rod has a reduced propensity to buckling such that it can support sufficient compressive load therein to support seat height adjustment. Further objects and advantages of the present invention will appear hereinbelow.

### SUMMARY OF THE INVENTION

In accordance with the present invention, it has now been found that the forgoing objects and advantages may be readily obtained.

The present invention provides a mechanical means to actuate the extending and/or retracting of the second portion relative to the first portion. This mechanical means includes a rod that serves to transmit motive force to push and extend and/or to pull and retract the second portion relative the first portion, thereby respectively raising and/or lowering the seat. US patent application No. 2025/0162673 (FIGS. 2a-x and 3a-d) provides further detail of the basic operation of an exemplary seatpost assembly applicable to the present invention. When the user wishes to lower the seat, the control rod is pulled within a sheath to retract the second member. When the user wishes to raise the seat, the control rod is pushed within a sheath to extend the second member, thereby subjecting the control rod to compressive longitudinal loading. It is preferable that the control rod be lightweight and also to have good flexibility and pliability characteristics so that it may easily accommodate bends in the sheath and accommodate being wrapped around the spool of a controller. As such, it is preferable that the rod have a relatively small cross section thickness. At the same time, the rod must exit the sheath and extend, unsupported by the sheath, to the second member. The longitudinal length of this unsupported portion of rod increases as the second member is extended relative to the first member.

During the extending of the second member, the rod is subject to longitudinal compressive loading in order to transmit the motive force. The compressive loading may induce buckling in the unsupported portion of the rod, which would detract from the rod's ability to transmit this motive force, especially in a controlled and predictable manner. It is well known that a large contributing factor to buckling of the rod, which may be considered a “column” in this case, is the “slenderness ratio”, which is related to both the longitudinal unsupported length and the cross-sectional dimension of the column. Since the rod may be considered a thin and slender element, it is preferable to reduce the longitudinal length of the unsupported portion of the rod as a means to mitigate its propensity for buckling due to compressive loading.

The present invention provides an “anti-buckle” apparatus, such as an “alignment system”, to provide lateral support to the otherwise unsupported portion of the rod that extends between the first and second members of the seatpost assembly. This apparatus preferably may be axially variable as the axial length of the otherwise unsupported portion of the rod is varied due to extension and retraction of the second member relative to first member.

The “anti-buckle” apparatus of the present invention serves to provide lateral support for the otherwise unsupported length of the rod, thereby mitigating its buckling where the otherwise unsupported portion of the rod may buckle in the absence of this “anti-buckle” apparatus. The “anti-buckle” apparatus permits the rod to be of relatively thin and slender cross section dimension in its otherwise unsupported portion, which permits the remainder of the rod to easily conform to the contours of the sheath and of any spool or other bending deflection necessary for optimal operation of the seatpost assembly, particularly in the extending direction. Further, the axial length of this “anti-buckle” apparatus may be may be axially variable and/or axially adjustable as the axial length of the otherwise unsupported portion of the rod is varied due to extension and retraction of the second member relative to the first member. The present invention allows for a single control rod to transmit motive force to the second member relative to the second member in both the extending and retracting directions.

By mitigating this propensity for buckling, the present invention provides for the controlled and predictable actuation of the seatpost assembly described in exemplary US patent application No. 2025/0162673 A1 (FIGS. 2a-x and 3a-d) and in other seatpost assemblies where a control rod experiences compressive or columnar loading. The present invention may also provide for transmitting motive force in both the extending and retracting directions with a single control rod.

Additional features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1a is a perspective view schematically illustrating the general configuration of a height-adjustable seatpost assembly, as conventionally adapted for bicycles, including description of the generic directions and orientations utilized throughout the specification;

FIG. 1b is an orthogonal view of an alternate seatpost assembly, showing the seatpost assembly of FIG. 1 as inverted such that the internal member is axially fixed while the external member is axially displaceable relative to the internal member and axially fixed to the seat;

FIG. 1c is a cross-section view of a prior art conventional seatpost assembly, having an arrangement similar to FIG. 1a, with the inner member shown in the extended and raised position.

FIG. 1d is a cross-section view of the seatpost assembly of FIG. 1c, with the inner member shown in the retracted and lowered position.

FIG. 2a is a perspective view of a seatpost assembly that is configured to receive the anti-buckle alignment system of the present invention, showing the seatpost assembly as assembled;

FIG. 2b is an exploded perspective view of the embodiment of FIG. 2a, showing the basic components of the seatpost assembly;

FIG. 2c is a cross-section view of the embodiment of FIG. 2a, taken along 35-35;

FIG. 2d is a cross-section view of the embodiment of FIG. 2a, taken along 36-36;

FIG. 2e is a cross-section view of the embodiment of FIG. 2a, taken along 37-37;

FIG. 2f is a cross-section view of the internal member of the embodiment of FIG. 2a, taken along 35-35;

FIG. 2g is a cross-section view of the internal member of the embodiment of FIG. 2a, taken along 38-38;

FIG. 2 h is a cross-section view of the external member of the embodiment of FIG. 2a, taken along 35-35;

FIG. 2i is a cross-section view of the external member of the embodiment of FIG. 2a, taken along 39-39;

FIG. 2j is an orthogonal view of the cam block of the embodiment of FIG. 2a;

FIG. 2k is a cross-section view of the cam block of the embodiment of FIG. 2a, taken along 40-40;

FIG. 2L is a cross-section view of the cam block of the embodiment of FIG. 2a, taken along 41-41;

FIG. 2m is a cross-section view of the control rod assembly of the embodiment of FIG. 2a, taken along 35-35;

FIGS. 2n-q are cross-section detail views of the seatpost assembly of the embodiment of FIG. 2a, taken along 35-35, showing the successive sequential steps in controlling the lowering axial advancement of the internal member with respect to the external member;

FIG. 2n shows the cam block initially in the locked position to provide axial locking between the internal and external members;

FIG. 20 shows the cam block as next advanced in the downwardly released position to release the axial locking between the internal and external members;

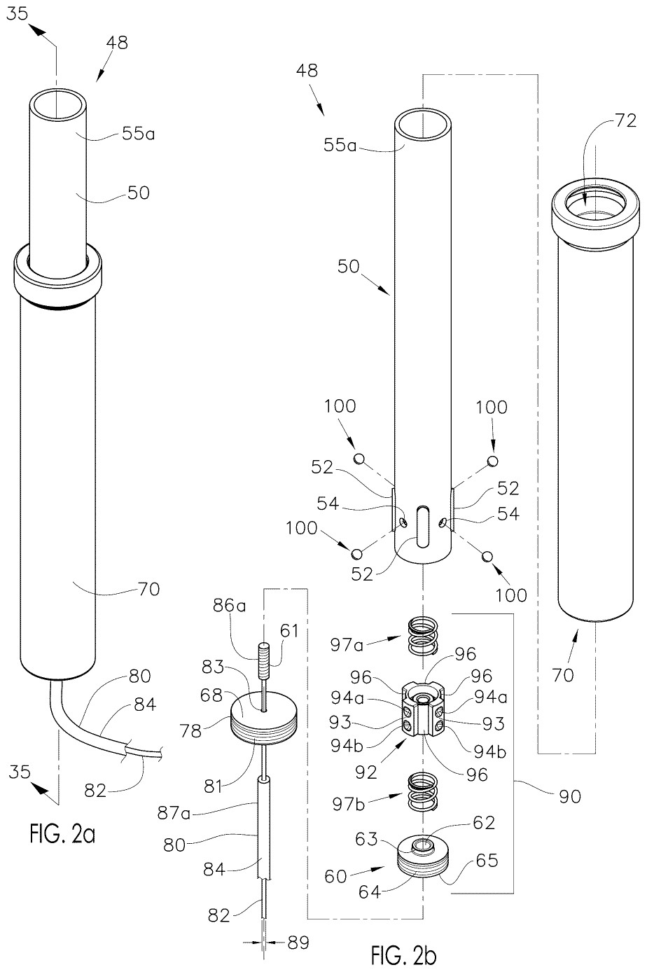

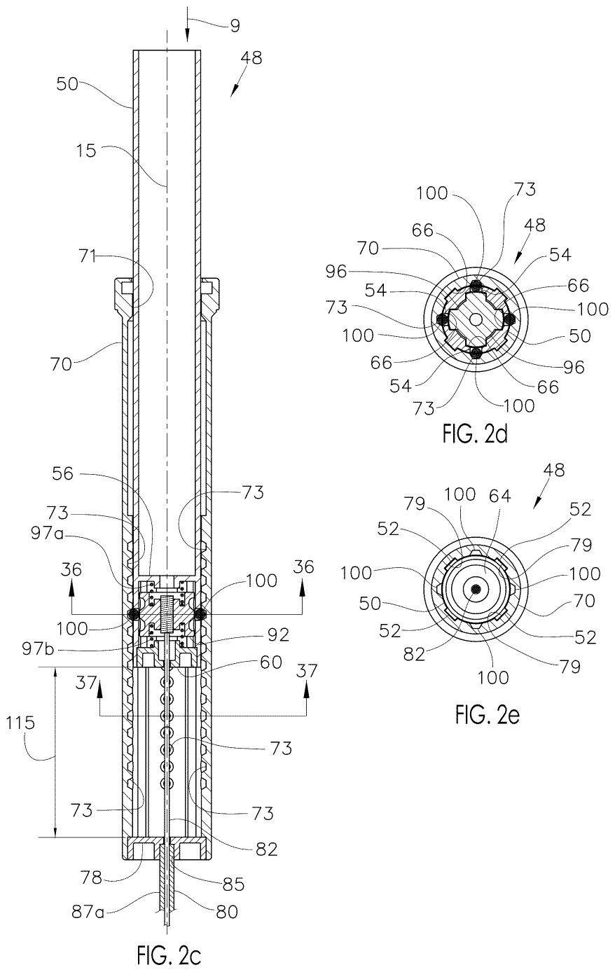

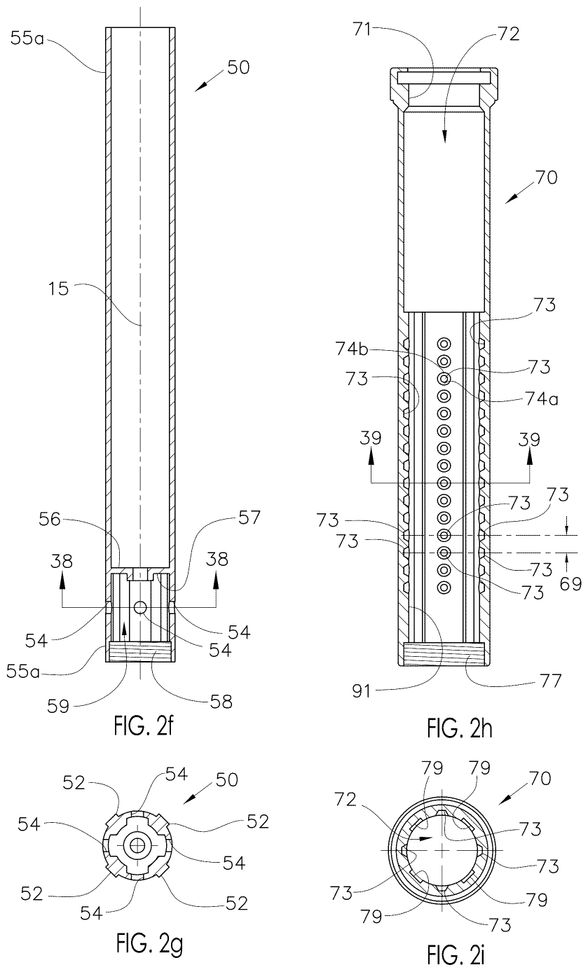

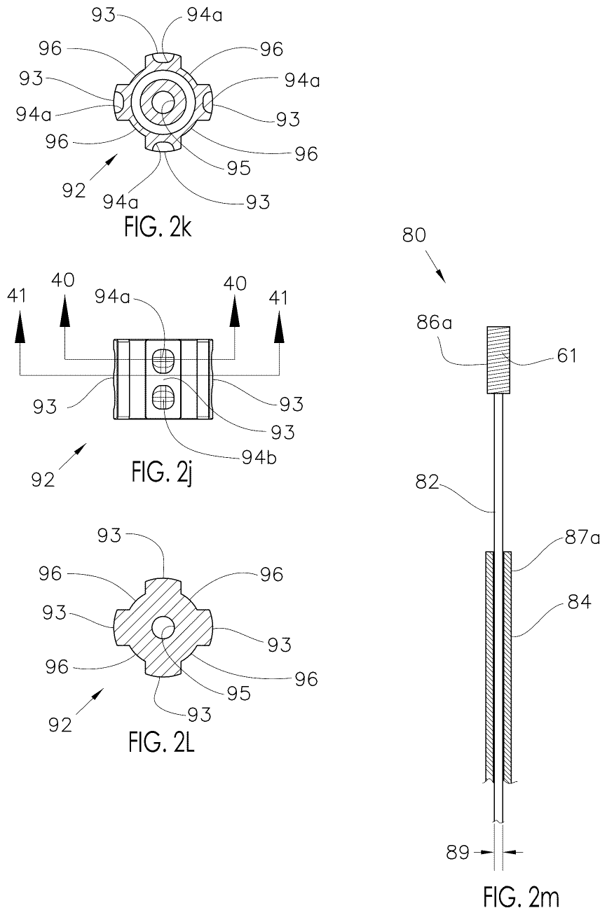

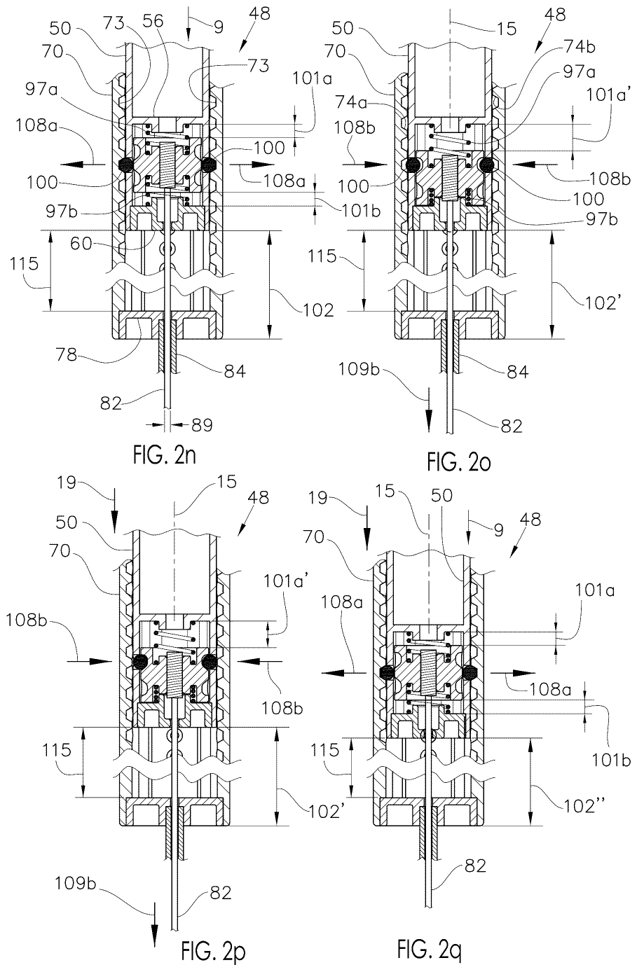

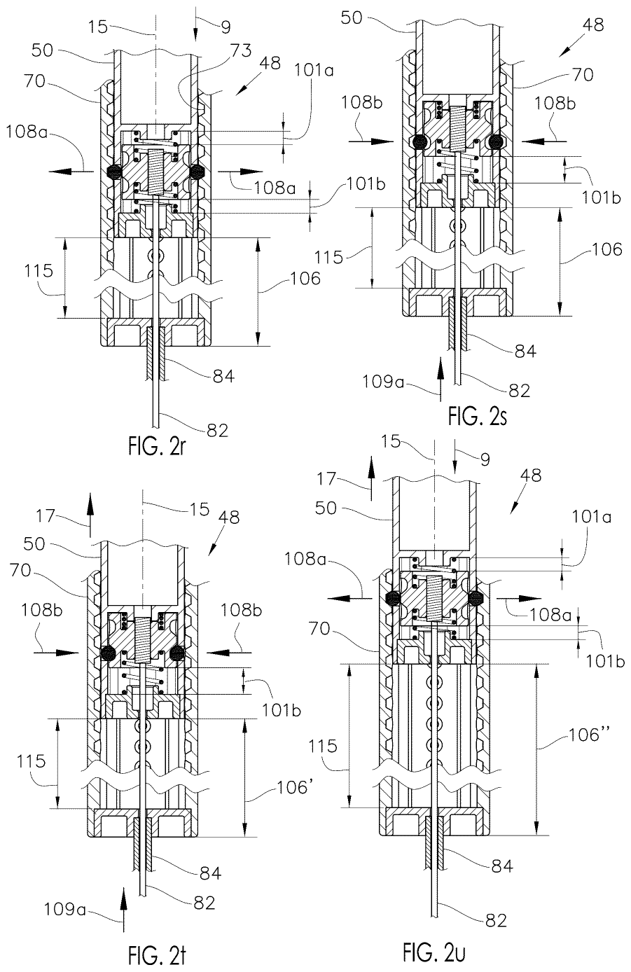

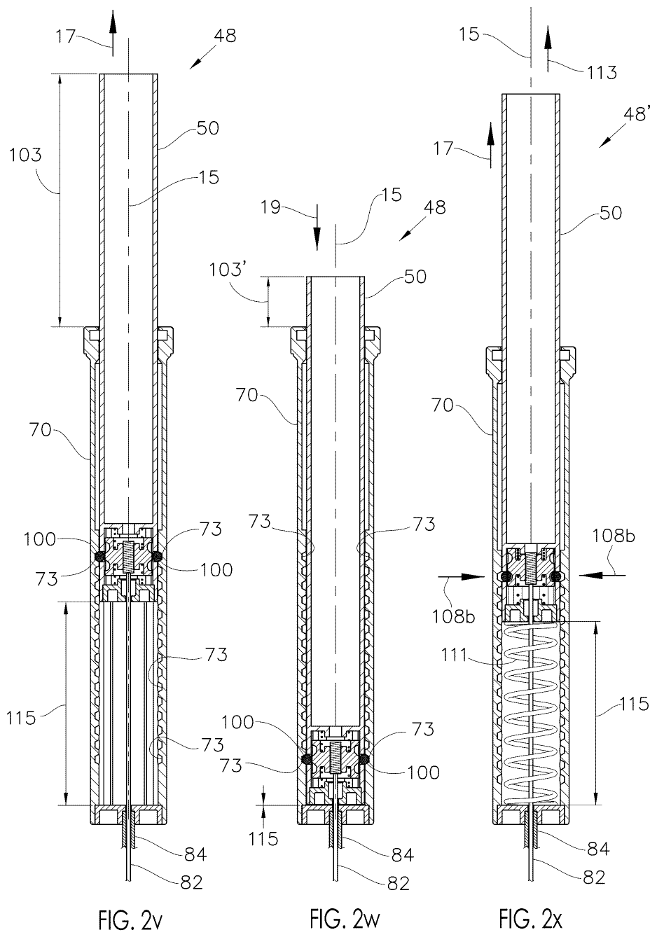

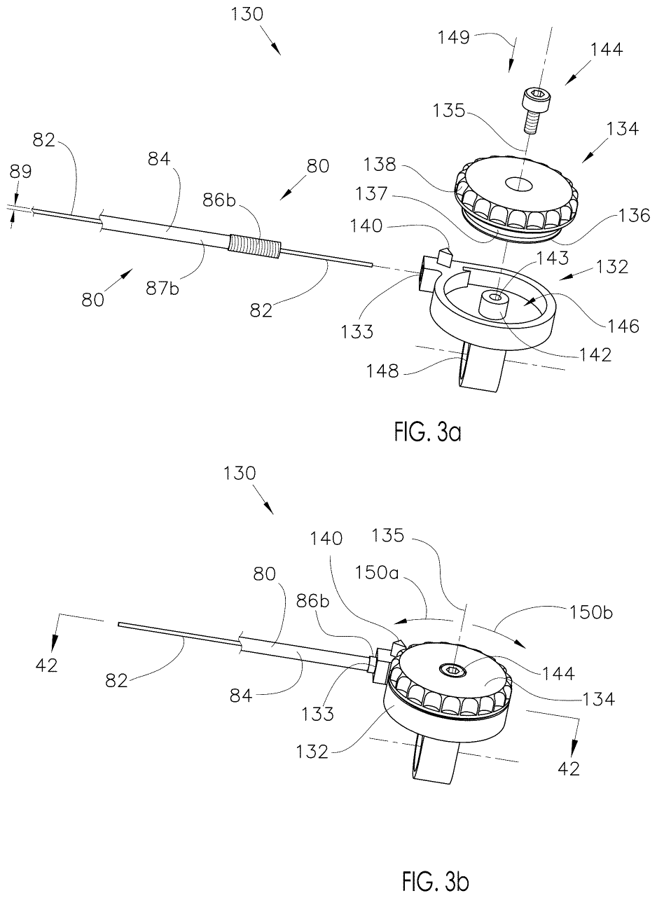

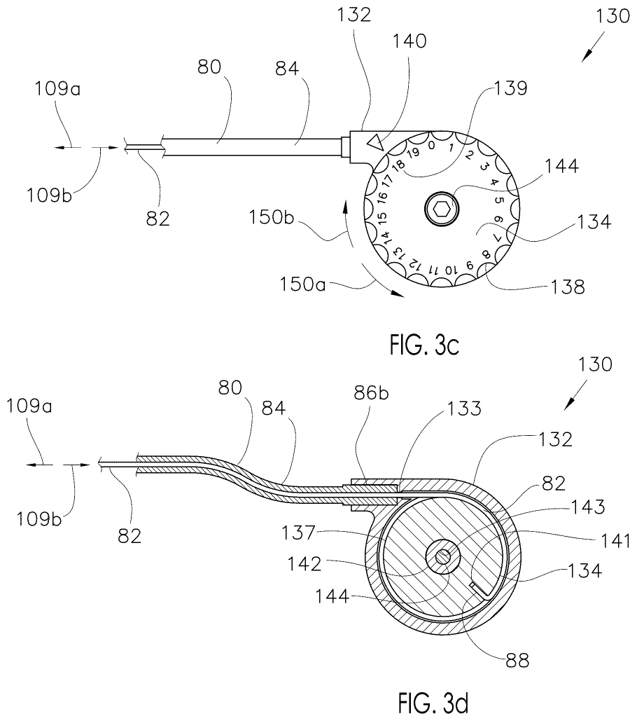

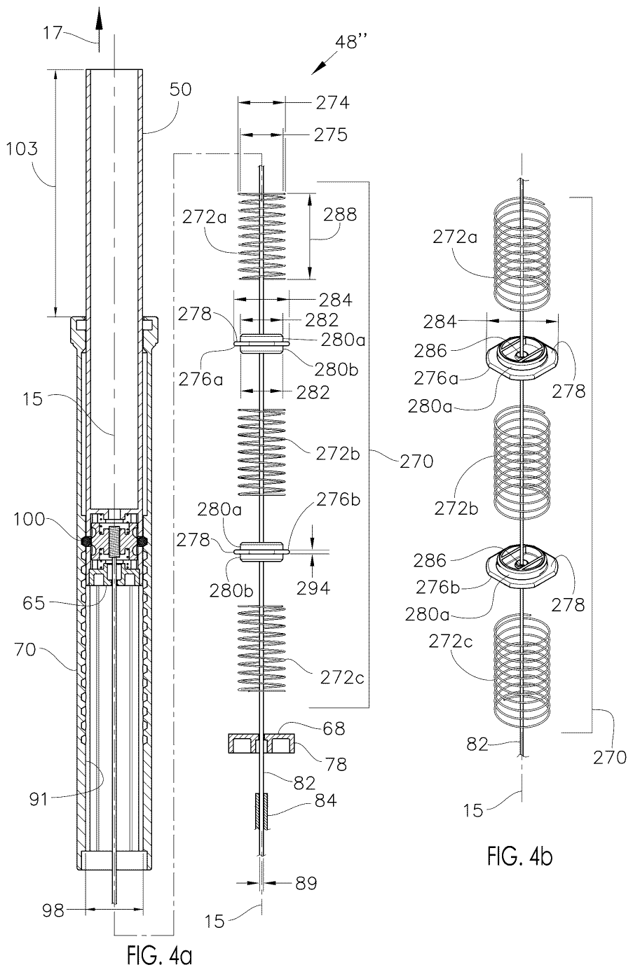

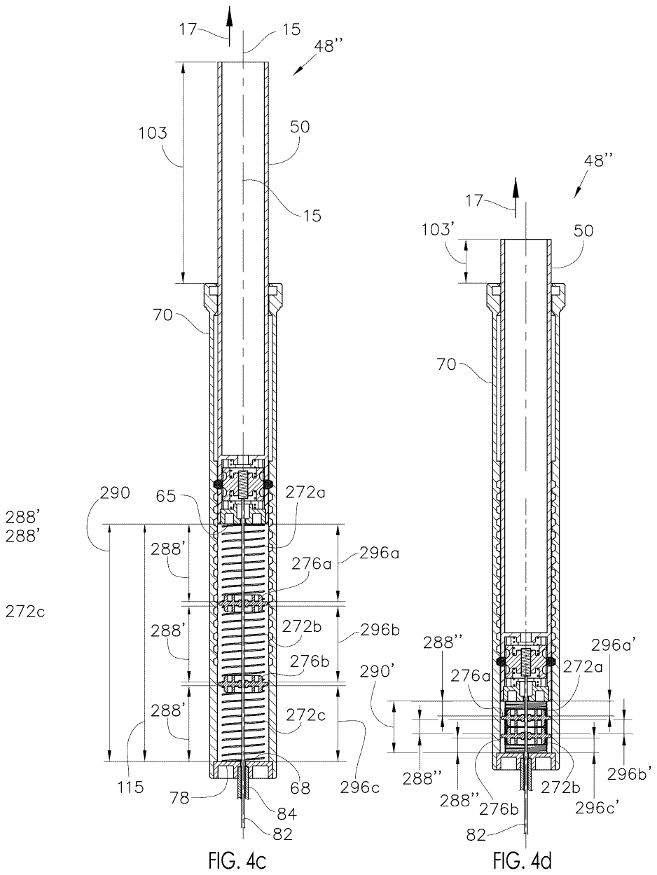

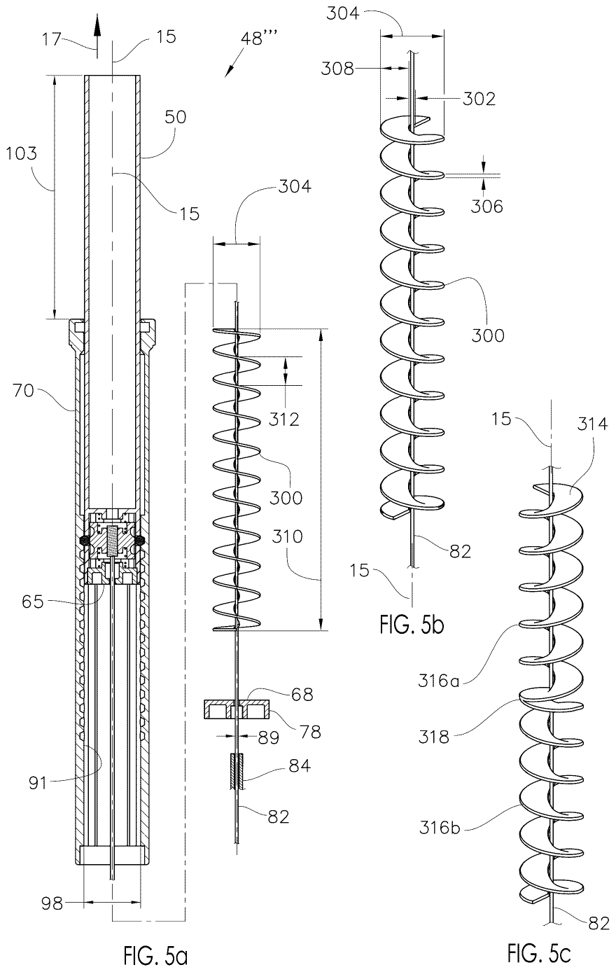

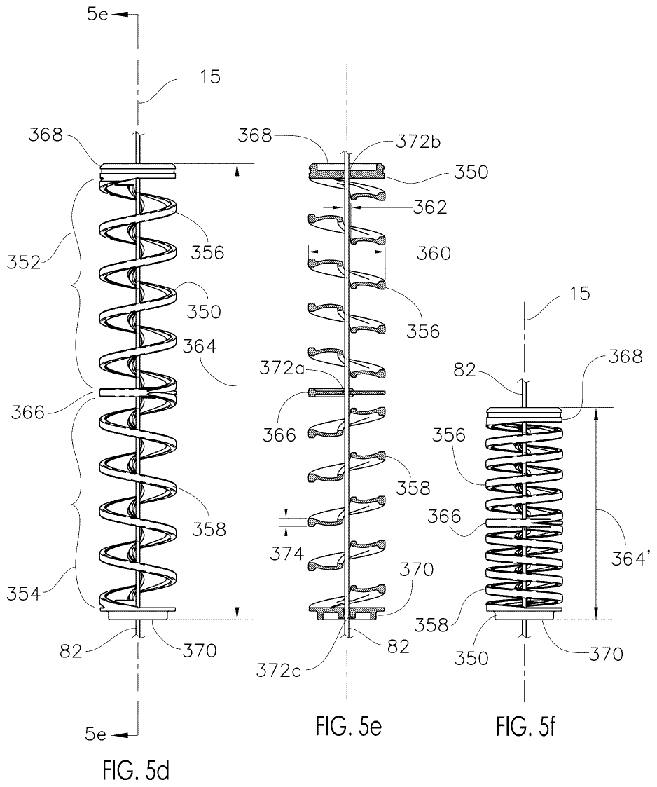

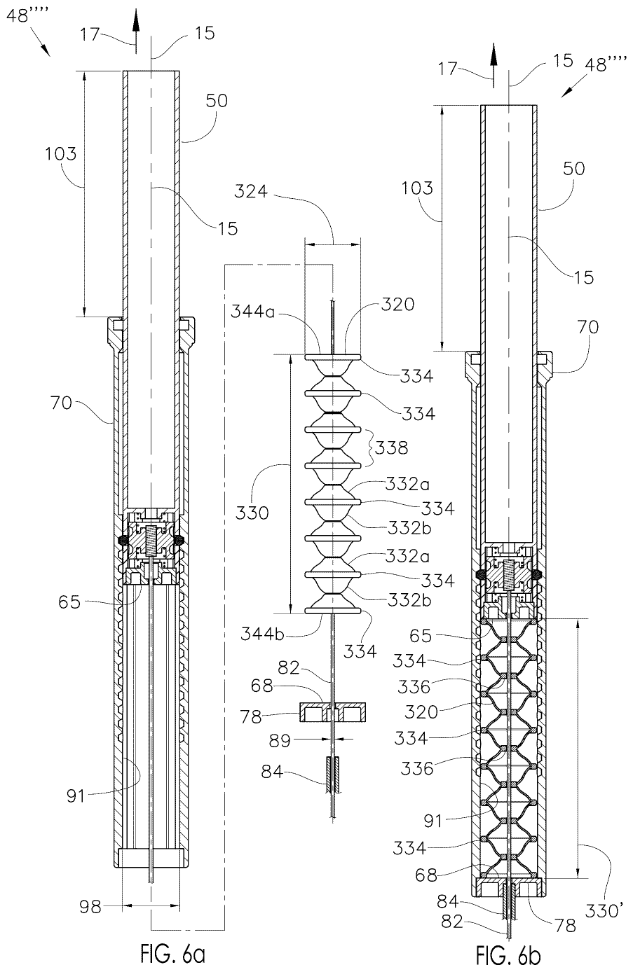

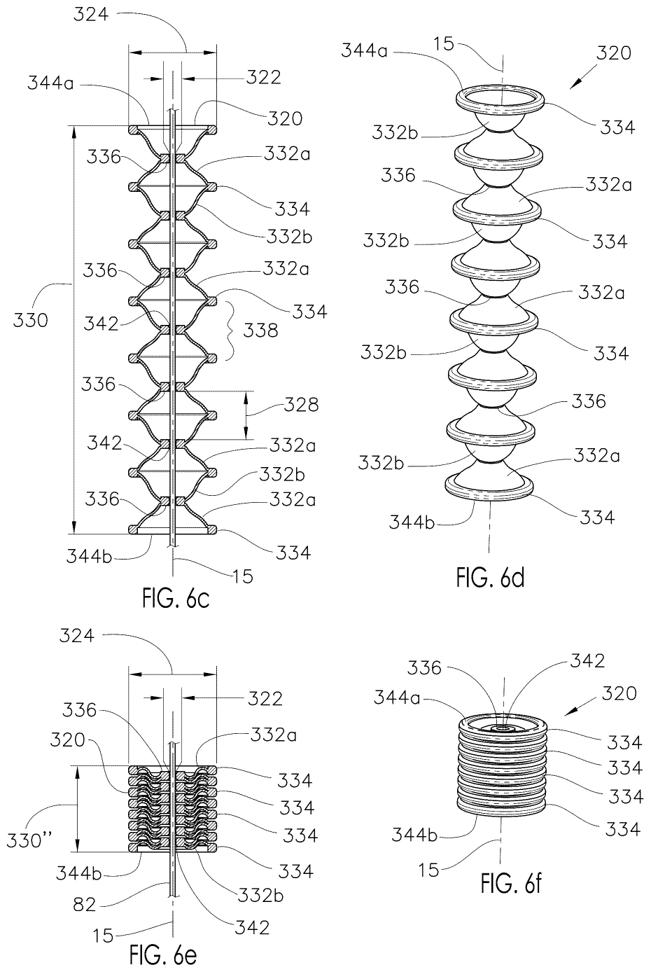

FIG. 2p shows the internal member as next axially advanced in the downward direction to lower the seat height to a lowered axial position;

FIG. 2q shows the cam block as next restored to the locked position to lock the lowered axial position of the internal member with respect to the external member;

FIGS. 2r-u are cross-section detail views of the seatpost assembly of the embodiment of FIG. 2a, taken along 35-35, showing the successive sequential steps in controlling the raising axial advancement of the internal member with respect to the external member;

FIG. 2r shows the cam block initially in the locked position to provide axial locking between the internal and external members;

FIG. 2s shows the cam block as next advanced in the upwardly released position to release the axial locking between the internal and external members;

FIG. 2t shows the internal member as next axially advanced in the upward direction to raise the seat height to a raised axial position;

FIG. 2u shows the cam block as next restored to the locked position to lock the raised axial position of the internal member with respect to the external member;

FIG. 2v is a cross-section view of the embodiment of FIG. 2a, taken along 35-35; showing the seatpost assembly locked in the fully raised and extended position;

FIG. 2w is a cross-section view of the embodiment of FIG. 2a, taken along 35-35; showing the seatpost assembly locked in the fully lowered and retracted position;

FIG. 2x is a cross-section view of a second embodiment of the present invention, corresponding to the view of FIG. 2v, including a spring to bias the internal member in the extending direction;

FIG. 3a is an exploded perspective view of an exemplary controller that is configured to be utilized in conjunction with the embodiment of FIG. 2a;

FIG. 3b is a perspective view of the controller of FIG. 3a, shown as assembled;

FIG. 3c is an orthogonal top view of the controller of FIG. 3a, shown as assembled;

FIG. 3d is a cross-section view, taken along 42-42 of the controller of FIG. 3a;

FIG. 4a is an exploded cross-sectional view, taken along 35-35 of a first embodiment of the present invention, showing the seatpost assembly of FIG. 2a also including an anti-buckle alignment system comprising a stack of springs and spacer discs;

FIG. 4b is an exploded partial perspective view of the anti-buckle alignment system of the embodiment of FIG. 4a;

FIG. 4c is cross-sectional view, taken along 35-35, of the embodiment of FIG. 4a, showing the seatpost assembly in the fully raised and extended position;

FIG. 4d is cross-sectional view, taken along 35-35, of the embodiment of FIG. 4a, showing the seatpost assembly in the fully lowered and retracted position;

FIG. 5a is an exploded cross-sectional view, taken along 35-35 of a second embodiment of the present invention, showing the seatpost assembly of FIG. 2a also including an anti-buckle alignment system comprising a helical spacer;

FIG. 5b is a partial perspective view of the anti-buckle alignment system of the embodiment of FIG. 5a;

FIG. 5c is a partial perspective view of a third embodiment of the present invention, including an anti-buckle alignment system comprising an alternate helical spacer that includes both clockwise and counterclockwise helical forms, with the helical spacer shown in its uncompressed free state;

FIG. 5d is an orthogonal view of a fourth embodiment of the present invention, including an anti-buckle alignment system comprising an alternate helical spacer that includes both clockwise and counterclockwise helical forms, with the helical spacer shown in its uncompressed free state;

FIG. 5e is a cross-sectional view, taken along 5e-5e, of the embodiment of FIG. 5d;

FIG. 5f is an orthogonal view of the embodiment of FIG. 5d, with the helical spacer shown as partially compressed from its free state;

FIG. 6a is an exploded cross-sectional view, taken along 35-35 of a fifth embodiment of the present invention, showing the seatpost assembly of FIG. 2a also including an anti-buckle alignment system comprising a bellows;

FIG. 6b is cross-sectional view, taken along 35-35, of the embodiment of FIG. 6a, showing the seatpost assembly in the fully raised and extended position;

FIG. 6c is a cross-sectional view, taken along 35-35, of the anti-buckle alignment system of the embodiment of FIG. 6a;

FIG. 6d is a partial perspective view of the anti-buckle alignment system of the embodiment of FIG. 6a;

FIG. 6e is a cross-sectional view, taken along 35-35, of the anti-buckle alignment system of the embodiment of FIG. 6a, showing the anti-buckle alignment system as axially compressed;

FIG. 6f is a partial perspective view of the anti-buckle alignment system of the embodiment of FIG. 6a, showing the anti-buckle alignment system as axially compressed.

### DETAILED DESCRIPTION OF THE INVENTION

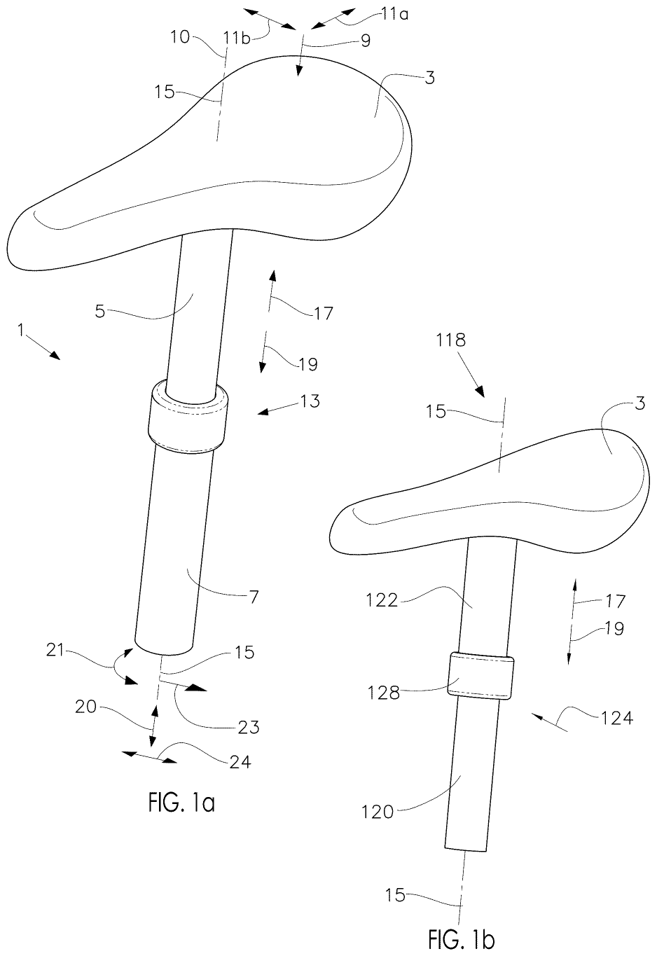

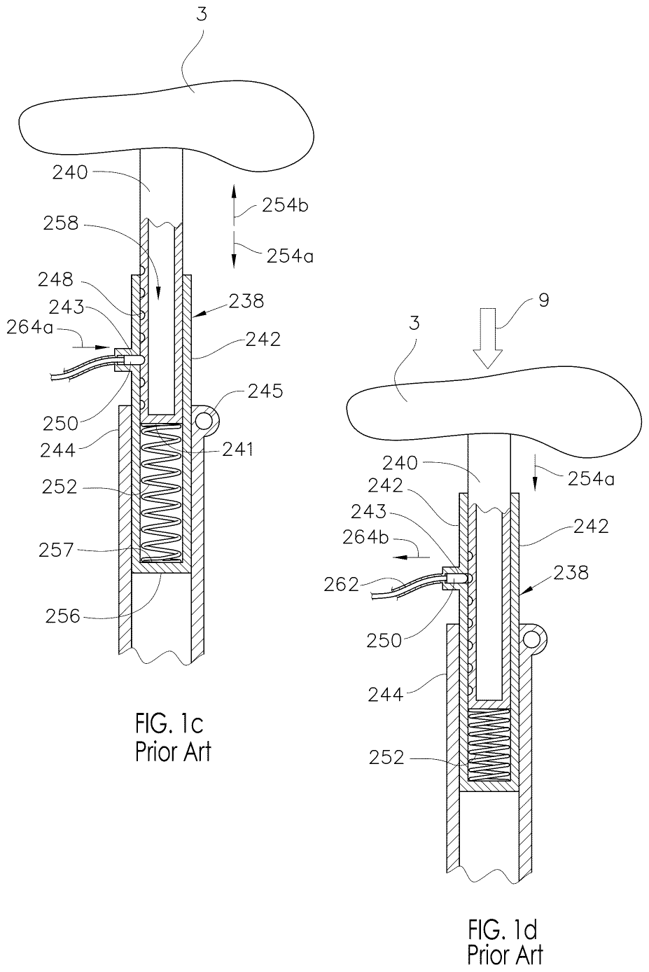

FIG. 1 describes the basic configuration of an exemplary height adjustable seatpost as adapted to a bicycle seat, as well as a description of the direction conventions used throughout this disclosure. For clarity, the corresponding bicycle frame is not shown in this figure.

The seatpost axis 10 extends along the general centerline of the seatpost assembly 1. The Seatpost assembly 1 consists of an internal member 5 that is telescopically guided within an external member 7 along an axial axis 15. Internal member 5 is adapted for mounting of a seat 3 in the conventional manner. The external member 7 is commonly fixedly mounted to the frame of a bicycle (not shown). The internal member 5 is moveable and may be telescopically displaced along axial axis 15 relative to the external member 7 to be generally upwardly raised and extended relative in the extending direction 17 and generally downwardly lowered and retracted in the retracting direction 19. The extending direction 17 and retracting direction 19 are both generally parallel to the axial axis 15. The extended orientation corresponds to reduced axial overlap between the internal member 5 and external member 7 while the retracted orientation corresponds to an increase in such axial overlap. The internal member 5 commonly has a maximum axial displacement or stroke relative to the external member 7 between a fully extended positional limit or end-stop and a fully retracted positional limit or end-stop. A mid-stroke position is a position between the fully extended limit and the fully retracted limit. The seatpost axis 10 and the axial axis 15 are generally collinear and may be used interchangeably throughout this disclosure except where noted. The seat 3 serves to generally support the weight of the rider, which corresponds to an axial load 9 applied to the seat 3. While the majority of load applied to the seat 3 by the rider is axial load 9, normal use also serves to induce radial loads 11a and 11b to the seat as well, which may impart a significant bending moment to the seatpost assembly 1.

In order to withstand these radial loads 11a and 11b, the seatpost assembly 1 must have sufficient structural strength and stiffness to support these loads. This is achieved through the robust telescopic guiding and circumferential keying between the internal member 5 and external member 7. This also requires that the internal member 5 and external member 7 have adequate strength and stiffness.

It is noted that the seat 3 is directly connected to the internal member 5. The seatpost assembly 1 preferably includes telescopic guiding and circumferential keying between the internal member 5 and external member 7. As such, there is preferably no necessity for any additional linkage or movable element that connects the internal member 5 to the frame (not shown) for this guiding or keying. This further supports the requirement that the seatpost assembly 1 be a structural assembly to support axial loads 9 as well as radial loads 11a and 11b.

The axial direction 20 is a direction along the axial axis 15. An axially raised orientation corresponds to the raised (or higher or elevated) orientation of the seat 3 while an axially lowered orientation corresponds to the lowered orientation of the seat 3. The radial direction 23 is also termed the lateral direction and is a direction generally perpendicular to the seatpost axis 10 and extends generally from the seatpost axis 10 radially outwardly. A radially inward orientation is proximal the seatpost axis 10 and a radially outward orientation is distal the seatpost axis 10. The circumferential direction 21 is a cylindrical vector that wraps around the seatpost axis 10 at a given radius. A downward or lower orientation is an orientation along the seatpost axis 10 that is proximal to the fixed member (shown here as the external member 7) and to the frame (not shown). Conversely, an elevated, upward, upper or raised orientation is axially opposed to the downward orientation and proximal the seat 3 (and distal to the fixed member and to the frame). A lateral direction 24 is a direction along a plane generally perpendicular to the axial axis 15, with a laterally inwardly orientation is an orientation proximal the axial axis 15 and a laterally outward orientation is an orientation distal the axial axis 15. The terms “axial displacement” and “axial position”, when referring to the seatpost assembly 1, correspond to the respective displacement and position of the internal member 5 (i.e. movable seatpost portion) relative to the external member 7 (i.e. fixed seatpost portion). In the case of a dropper seatpost, it may be considered that the term “motive force” refers to a force input (regardless of direction) to the seatpost assembly 48 that drives the axial displacement. The term “actuator” is the apparatus that converts the motive force into the axial displacement.

The arrangement described in FIG. 1a corresponds to the arrangement described in FIGS. 2a-w, however the generic terms and schematic arrangement described in FIG. 1a may also generically correspond to any of the figures herein. It is understood that these generic terms may also be applied to a wide range of alternate configurations. In one such alternate example, the seatpost assembly 124 may in an upside-down configuration, as shown in FIG. 1b, where the internal member 120 may be positioned below the external member 122 and may be fixed to the frame (not shown), with the external member 122 fixed to the seat 3 and telescopically displaceable in directions 17 and 19 relative to the internal member 120.

While FIG. 1a describes a seatpost assembly 1 where the external member 7 is axially fixed to the frame (not shown) and the internal member 5 as axially displaceable relative to the internal member 5 and fixed to the seat 3. The axial displacement thus serves to selectively adjust the height of the seat 3. However, this is but one possible arrangement. FIG. 1b shows an alternate arrangement whereby the arrangement of FIG. 1a is transposed to provide an upside-down seatpost assembly 118 with an internal member 120 that is axially fixed to the frame (not shown) and an external member 122 that is axially displaceable relative to the internal member 120 and fixed to the seat 3. This axial displacement also serves to selectively adjust the height of the seat 3.

While the internal member 5 and external member 7 are shown here to be generally linear elements that extend longitudinally along a generally straight axial axis 15, it is envisioned that, in a second alternate configuration, the telescopic or axial axis 15 need not necessarily be straight and longitudinal. For example, the internal and external members may alternatively be arcuate elements, with the internal member displaceable relative to the external member along an arcuate axial axis.

FIGS. 1a-b shows the external member 7 and internal member 120 to each be formed as a separate element that is fixedly connected to the frame of a bicycle (not shown). It is envisioned that external member 7 and internal member 120 may each be formed as a portion of the frame itself, thus eliminating the aforementioned connection.

FIGS. 1c-d describe, in schematic form, a prior art conventional dropper seatpost. Seatpost assembly 238 includes an external member 242, an internal member 240 telescopically guided within external member 242, a spring 252 in the form of a compression spring, and a peg 250 that is remotely operable to engage and disengage from a series of sockets 248 in the internal member. External member 242 includes axially extending opening 243 and is closed at its lower end 256 to include end face 257. External member includes an opening 258 for passage of peg 250 therethrough. External member is also secured to the seat tube 244 of a bicycle frame in the conventional manner by tightening pinch bolt 245. Internal member 240 includes a series of axially spaced sockets 248 sized to receive peg 259 and is adapted to secure the seat 3 in the conventional manner. Spring 252 is braced between the bottom end 241 of the internal member 240 and the end face 257 as shown.

Peg 250 is guided within opening 258 such that it may be laterally shuttled in directions 264a and 264b therein, in directions 264a and 264b, to be actuated between an engaged orientation where the peg 250 is laterally inwardly positioned to engage with a selected socket 248 and a disengaged orientation where the peg 250 is laterally outwardly withdrawn to disengage with the selected socket 248. It is preferred that the peg 248 may be remotely actuated by a remote lever (not shown) that controls the lateral position of the peg 250 through a cable and sheath as is commonly utilized.

FIG. 1c shows the seatpost assembly in the raised and extended orientation where the peg 250 is shuttled in direction 264a to an engaged orientation and to be engaged to a lower one of the sockets 248, which serves to lock the position of the internal member 240 in this raised and extended orientation. If the user elects to lower the seat, he/she operates the remote lever to move the peg 250 to the disengaged orientation, freeing the internal member to be retracted. The user then sits on seat 3 to apply axial load 9 against the seat 3 with their buttocks to telescopically displace the internal member 240 in the downward direction 254a, retracting the internal member 240 and compressing spring 252 until an upper one of the sockets 248 is aligned with opening 258. The user then operates the lever to move the peg 250 back to the engaged orientation, which serves to lock the position of the internal member 240 in this newly lowered and retracted orientation of the seatpost assembly 238. The telescopic displacement of the seatpost assembly 238 and corresponding height of the seat 3 may be subsequently raised and extended by operating the peg 240 as described above. However, when raising and extending the internal member 240 in direction 254b, the user will commonly reduce the force 251 against the seat and allow the stored energy of the spring 252 to push the internal member 240 in direction 254b and then increase pressure against the seat 3, while the peg 250 is in the disengaged orientation, in an attempt to restrain the axial displacement of internal member 240 at a desired extended and raised position. The user then manipulates the peg 250 to the engaged orientation.

The seatpost assembly 238 is shown here as a greatly simplified and schematic arrangement provided for illustration purposes. Modern conventional dropper seatposts are commonly more sophisticated and utilize an air spring in place of the wire compression spring 252 and pneumatic or hydraulic valving for locking in place of the peg 250 and socket 248 engagement, among other refinements. FIGS. 1a-b clearly describes how the user must press against the seat 3 to provide the motive force 251 to passively displace the seatpost assembly 238 in the retracting direction 254a, and must also passively press against the seat 3 to modulate and control the axial displacement of the seatpost assembly 238 in the extending direction 254b. The motive force in the extending direction is provided by the energy of the spring 252, however the spring is “dumb” in that it continues to provide motive force regardless of the axial position of the internal member 240 relative to the external member 242. As such, the modulating the force of the user's buttocks against the seat 3 is required to control the degree and position of axial displacement of the seatpost assembly 238 during seat height adjustment. The user's buttocks have limited dexterity in this capacity and it is difficult, if not impossible, to precisely control the seat height when axially displacing the seatpost assembly 238 to a mid-stroke position. Since the remote lever only controls the engagement/release of the peg 250, it cannot provide any feedback to the user as to the seat height. Instead, the user must gauge seat height by “feel” through his/her buttocks and leg extension, which is certainly a very unreliable means of feedback.

FIGS. 2a-w describe a first embodiment of a seatpost assembly 48, including an internal member 50, an external member 70, a control rod assembly 80, a cam assembly 90, and balls 100. Although not detailed, the internal member 50 is adapted for mounting of a seat 3 (not shown) adjacent its first end 55a in the conventional manner.

Cam assembly 90 includes cam block 92 that is axially sandwiched between springs 97a and 97b. Cam block includes: four upper recesses 94a and four lower recesses 94b axially spaced therefrom and having a blocking surface 93 axially located therebetween. Each pair of axially aligned recesses 94a and 94b are circumferentially spaced about the axial axis 15 as shown; axially extending channels 96, with each channel 96 circumferentially positioned between adjacent recess 94a and 94b pairs; and a receiver 95 in the form of an internal threaded hole 95 to receive the mating external threads 61of the connector 86a.

External member 70 includes: opening 72 to receive internal member 50; interior surface 91; bushing 71 for guiding of internal member 50; four circumferentially spaced columns of sockets 73; axially extending grooves 79, with each channel 96 circumferentially positioned between adjacent columns of sockets 73; and internal threads 77. Individual sockets 73 of each column are preferably spaced at an even axial interval such that the individual sockets 73 of adjacent columns are axially coincident as shown. Sockets 73 are shown to be frustoconical in shape, although they may be straight cylindrical or may simply be comprised of individual circumferential grooves or other radially outwardly recessed geometry. Cap 78 includes external threads 81 to threadably mate with internal threads 77; and hole 83 providing clearance for passage of control rod 82, with counterbore 85 to receive the end portion 87a of sheath 84.

Internal member 50 is a generally cylindrical element that includes four circumferentially spaced keys 52 that are aligned to slide within grooves 79 to provide a guided and axially slidable bushing engagement between the internal member 50 and external member 70 and also to limit and prevent rotation between the internal member 50 and external member 70 to maintain circumferential alignment therebetween as the internal member 50 is extended and retracted. It is preferred that the internal member 50 be of a lightweight high strength material such as aluminum or fiber-reinforced composite and that the keys be made of rigid lubricious material such as nylon or acetal polymer. Internal member 50 also includes: four circumferentially spaced and axially coincident holes 54 sized to receive balls 100; internal wall 56 having bearing surface 57 to brace against spring 97a; opening 59 to receive the cam assembly 90; axially extending grooves 66, with each groove 66 circumferentially positioned in alignment with a corresponding hole 54; and internal threads 77. Cap 60 includes a pilot collar 63 for radial piloting of spring 97b; hole 62 to provide clearance for passage of control rod 82; and external threads 64 to threadably mate with internal threads 77.

Control rod assembly 80 is of conventional configuration and includes a longitudinal control rod 82 guided within a housing or sheath 84. The control rod 82 has a cross-section dimension and in the case of a control rod 82 with circular cross section the cross-section dimension is diameter 89. The control rod 82 includes a connector 86a at the end proximal the cam block 92 and a bent portion 88 (see FIG. 3d) at the end proximal the controller assembly 130 (see FIGS. 3a-d). Connector 86a includes external threads 61 for threadable assembly with the internal threads of receiver 95.

These components are assembled as particularly shown in FIG. 2c to create seatpost assembly 48. Connector 86a is threadably connected to the receiver 95 of cam block 92. Cap 60 is assembled to internal member 50, with threads 64 threadably engaged to threads 58 to capture the spring 97a, cam block 92 and spring 97b as shown. Spring 97a is a compression spring and is braced between the bearing surface 57 and the cam block 92. Spring 97b is also a compression spring and is braced between the cam block 92 and the cap 60. Channels 96 are aligned to be axially guided with grooves 66 such that recesses 94a and 94b are also circumferentially aligned with holes 54. The internal member 50 is sleevably assembled with the external member 70 as shown, including balls 100 positioned within corresponding holes 54, such that keys 52 are axially guided within respective mating grooves 79. Cap 78 is assembled to external member 70, with threads 81 threadably engaged to threads 77 to capture the internal member 50 within the opening 72 of external member 70.

Balls 100 are positioned within holes 54 and radially bounded between the external member 70 and cam block 92. Recesses 94a and 94b are radially inboard surfaces to receive balls 100, while blocking surfaces 93 are radially outboard of recesses 94, such that axial displacement of the cam block 92 serves to cam and radially displace the balls 100 within holes 54 between a radially inboard position when recesses 94 are axially aligned with holes 54 and a radially outboard position when blocking surfaces 93 are axially aligned with holes 54. Springs 97a and 97b serve to axially bias the cam block 92 toward the radially outboard position where blocking surfaces 93 are axially aligned with holes 54.

As shown in FIGS. 2c-d, balls 100 are axially aligned with respective blocking surfaces 93 such that the balls 100 serve as a key span between holes 54 and sockets 73 to axially lock the internal member 50 and external member 70 to support axial load 9, which corresponds to the seating load of the rider (not shown).

FIGS. 2n-q details the sequence where the control rod 82 is used to displace the internal member 50 in the retracting direction 19 from a first axial position to a second and lower axial position. As shown in FIG. 2n, which corresponds to FIG. 2c, the control rod 82 has not yet been displaced and the cam assembly 90 is in its “home position” where the springs 97a and 97b are balanced such that dimensions 101a and 101b are equal and the axial position of the cam block 92 relative the internal member 50 is maintained by springs 97a and 97b such that the blocking surfaces 93 are axially aligned and overlapping their respective holes 54. This serves to push balls 100 in the radially outward direction 108a to a radial outward position, with blocking surfaces 93 axially aligned with balls 100 as shown in FIG. 2n. Blocking surface 93 serve to maintain this radial outward position such that balls 100 radially overlap both the holes 54 and the mating sockets 73. As such, balls 100 span and bridge between the internal member 50 and external member 70, thus engaging, latching, and locking the axial position of these two members (50 and 70) together and maintaining the corresponding seat height and supporting axial load 9. Blocking surfaces 93 serve to block balls 100 from moving radially inward, thus maintaining this locked engagement. This is considered the “locked” or “latched” orientation of the cam assembly 90. A seat (not shown) connected to the internal member 50 can support axial load 9.

Next, the control rod 82 is longitudinally shuttled and displaced within sheath 84 in direction 109b as shown in 20, which serves to compress spring 97b and axially displace the cam block 92 in direction 109b relative to the internal member 50, reducing dimension 101b (and correspondingly increase dimension 101a) until recesses 94a are axially aligned with their respective holes 54. This initial displacement removes the blocking engagement of FIG. 2n and permits the balls 100 to move radially inwardly in direction 108b until the balls 100 are no longer radially overlapping sockets 73 as shown in FIG. 20. This removes the locking bridge between the internal member 50 and external member 70 and is considered the “downwardly released” orientation of the cam assembly 90. This initial displacement of the cam block 92 is considered to be “lost motion” of the control rod 82 because this displacement serves only to release the locking bridge and does not (yet) serve to advance the internal member 50 in direction 109b.

Further displacement of the control rod 82 in direction 109b serves to provide motive force to actively pull and axially displace the internal member 50 in retracting direction 19. Selective displacement of the control rod 82 in direction 109b serves to correspondingly actively retract the internal member 50 until a new targeted lowered seat height is achieved as shown in FIG. 2p. The axial position of the control rod 82 relative to the external member 70 is then maintained such that springs 97a and 97b serve to bias the cam block 92 in direction 109a back toward the latched home position, biasing and pushing the balls 100 radially outwardly out of their recesses 94a until they engage and radially overlap a new set of sockets 73 that correspond to the newly selected and lowered seat height. The balls 100 again provide a locking bridge between the internal member 50 and external member, and the cam assembly 90 is again in the home and locked position described in FIG. 2n and shown in FIG. 2q. The cam assembly 90 is now latched and locked in an axial position associated with the socket 73 to which the balls 100 are engaged. The internal member 50 may again support axial load 9.

The cam assembly 90, holes 54, balls 100, and sockets 73 may be considered to be a latching mechanism, serving to latch and unlatch the axial displacement of the internal member 50 relative to the external member 70 as described herein. It may be seen that the internal member 50 may be axially displaced in discrete increments corresponding to the axial distance 69 between axially adjacent sockets 73 and/or may be axially advanced to bypass the axial position associated with a given socket(s). This latching mechanism has an input end, where motive force and actuation is input from the rod 82 to the cam block 92 of the latching assembly, and an output end, where the motive force and actuation is transmitted from the cam block 92 and spring 97a to the internal member 50. The aforementioned “lost motion” occurs between the input end and output end.

A latching mechanism is defined herein as a mechanism or system that is functional to selectively: (i) latch and restrain the telescopic displacement of the internal member relative to the external member; and to (ii) unlatch and release this restraint to permit this displacement. It is preferable that this latching and un-latching may be selectively controlled as shown in the embodiment of FIGS. 2a-w. The latching mechanism may provide this latching through mechanical engagement between the inner and outer members, as described in FIGS. 2a-x, and/or by restricting hydraulic fluid flow as described in FIGS. 4a-j, and or by another restraining means such as magnetic restraint among others.

It may be preferable that the motive force applied at the input end of the latching mechanism be greater or lesser than the motive force transmitted at the output end. It may alternatively be preferable that the latching mechanism include further features to provide a self-energizing function, where passive downward force applied to the seat 3 may serve to augment the latching of the latching mechanism.

It is noted that the control rod assembly 80 is braced between the cam block 92 and the cap 60 that is below the cam block 92 such that the rod 82 is pulling (i.e. in tension) the internal member 50 downward when axially displaced in the retracting direction 19. By pulling the rod, the rod 82 cannot buckle. This is in contrast to prior art dropper seatposts, where active displacement is commonly actuated in a pushing direction to push (in compression) against an associated internal member.

FIGS. 2r-u detail the sequence where the control rod 82 is used to displace the internal member 50 in the extending direction 17 from a first axial position to a second and raised axial position. As shown in FIG. 2r, the control rod 82 has not yet been displaced and the cam assembly 90 is in its “home position” as described in FIG. 2n. Next, the control rod 82 is longitudinally shuttled and displaced within sheath 84 in direction 109a as shown in 2s, which serves to compress spring 97a and axially displace the cam block 92 in direction 109a relative to the internal member 50, reducing dimension 101a (and correspondingly increase dimension 101b) until recesses 94b are axially aligned with their respective holes 54. This removes the blocking engagement of FIG. 2r and permits the balls 100 to move radially inward in direction 108b until the balls 100 are no longer positioned within sockets 73 as shown in FIG. 2s. This removes the locking bridge between the internal member 50 and external member 70 and is considered the “upwardly released” orientation of the cam assembly 90. Again, this initial displacement of the cam block 92 is considered to be “lost motion” of the control rod.

Further displacement of the control rod 82 in direction 109a serves to provide motive force to actively push and displace the internal member 50 in the extending direction 17. Selective displacement of the control rod 82 in direction 109a serves to correspondingly actively extend the internal member 50 until a new raised seat height is achieved as shown in FIG. 2t. The axial position of the control rod 82 is then selectively released at this desired target position and the springs 97a and 97b serve to bias the cam block 92 back toward the home position, biasing and pushing the balls 100 radially outwardly out of their recesses 94a until they engage and radially overlap a new set of sockets 73 that correspond to the newly selected and raised seat height. The balls 100 again provide a locking bridge between the internal member 50 and external member and the cam assembly 90 is again in the latched home position described in FIG. 2n and shown in FIG. 2u. Internal member 50 has thus now been axially retracted and locked in a lowered mid-stroke position relative to the external member 70.

FIG. 2v shows the seatpost assembly 48 as raised to the fully extended orientation, where the internal member 50 is axially displaced to protrude from the external member by dimension 103. The balls 100 are shown to be mated and engaged to the uppermost sockets 73, which corresponds to the upper limit of extension of the internal member 50. Conversely, FIG. 2w shows the seatpost assembly 48 as lowered to the fully retracted orientation, where the internal member 50 is protruding from the external member by dimension 103′, which is smaller than dimension 103. The balls 100 are shown to be mated and engaged to the lowest sockets 73, which corresponds to the lower limit of retraction of the internal member 50.

The operation and function of the embodiment of FIGS. 2a-w and 3a-d provides a significant departure from prior art seatpost assemblies. Firstly, it is noted that the longitudinal shuttling of the control rod 82 within the sheath 84, and correspondingly the longitudinal shuttling of the cam block 92, serve to provide active motive force to actuate the axial displacement of the internal member 50 in directions 17 and/or 19. This is in contrast to the rotary motive force of U.S. Pat. No. 11,661,130, which relies on the rotation of an electric motor for motive force.

Secondly, the longitudinal shuttling of the control rod 82 provides an active input and motive force to the seatpost assembly 48 to both advance and control displacement of the internal member 50 in directions 17 and/or 19. In other words, the present invention serves to “actively” control the displacement of the internal member 50 and correspondingly raise and/or lower the seat (not shown). This “active” input is in contrast to the “passive” input of conventional seatpost assemblies 238, where the user must apply motive force 251 against the seat (and internal member 240 fixed thereto) in order to displace the internal member 240 in the retracting direction 254a. Similarly, the user must apply passive force 251 against the seat 3 to control the axial displacement of the seatpost assembly 238 when the internal member is displaced in the extending direction 254b. In other words, prior art seatpost assemblies require force against the seat to “passively” provide motive force and “passively” control the displacement of its internal member and correspondingly raise and/or lower its seat.

Thirdly, the present invention may provide for remote actuation and control of the seatpost assembly 48, where a controller assembly 130 that is remote from the seatpost assembly 48 may be manipulated to selectively control the axial displacement of the internal member 50 in directions 17 and/or 19. The controller assembly 130 may also be manually manipulated by the user to provide a remote source of motive force to extend and/or retract the seatpost assembly 48. In contrast, prior art seatpost assemblies may sometimes provide a remote lever that serves merely to selectively release a locking mechanism (258, 250, 248) within its seatpost assembly 238 to allow its internal member 240 to be axially displaced. This control lever does nothing to actuate or provide motive force to selectively control the height of the seat.

Fourthly, prior art seatpost assemblies require some degree of stored energy within the seatpost assembly itself in order to provide motive force to displace its internal member in the extending direction. This stored energy is commonly provided by a mechanical spring or gas spring, which can only provide motive force in one direction. Motive force in the opposite direction must be provided from another source, which may be compressed air or electricity stored in a battery, etc. These other sources are expendable and depleted through repeated actuation of their motive force, meaning that these sources must be regularly recharged to function. In contrast, the present invention, while it may include some stored energy, this is not a requirement and the present invention may provide such motive force through manual manipulation by the user. Such motive force lasts the life of the user and is not depleted.

It is preferred that the user take their weight off of the seat during raising and lowering of the seat height as described in the sequences described in FIGS. 2r-u and 2n-q. This reduced the motive force required to displace the control rod 82 in directions 17 and 19 and also minimizes “push-back” in direction 19 where the user's weight would otherwise push against the control rod 82 during the upwardly-released and/or downwardly-released orientations of the cam assembly 90.

FIG. 2x describes an embodiment identical to that of FIGS. 2a-w, with the exception that a compression spring 111 is incorporated into the seatpost assembly 48′. The spring 111 is braced between the caps 78 and 60 and serves to bias the internal member 50, by bias force 113, in the extending direction 17 relative to the external member 70. Bias force 113 may be helpful to counterbalance the weight of the internal member 50 and the seat (not shown) connected thereto to assist in the intended function of the seatpost assembly 48′ while the latching mechanism is in the released position and/or reduce the amount of motive force required to axially displace the inner member 50 in the extending direction 17. Alternatively, an extension spring may be substituted for compression spring 111, which would bias the internal member in the retracting direction 19. As a further alternative, a different type of device may be substituted for the spring 111, to provide a biasing motive force. Such a device may include magnets (for magnetic repulsion/attraction force), pressurized air storage, among others discussed herein and those known in industry.

It is noted that controller assembly 130 and seatpost assemblies 48 and 48′ shown in these figures are a schematic representations for explanatory purposes only. It is understood that further detail of these assemblies may be required for practical use.

FIGS. 3a-d describe a controller assembly 130 that may be utilized in conjunction with the seatpost assembly 48 or 48′. Controller assembly 130 includes: screw 144; knob 134; and base 132. Note that control rod assembly 80 is the same assembly utilized and shown in FIGS. 2a-w, however FIGS. 3a-d show its opposite end for connection with the controller assembly 130. Control rod assembly 130 further includes connector 86b fixed to the end portion 87b of the sheath 84, which is opposed to the end portion 87a that is connected to the seatpost assembly 48 or 48′.

Base 132 includes: a shaft 142 serving as an axle for rotation of the knob 134; a recess 146 to receive the spool 136 and the control rod 82 wrapped around it as shown in FIG. 3d; hole 143 that is internally threaded to threadably receive screw 144; opening 133 to receive connector 86b; registration mark 140 for visual alignment feedback with the knob 134; and an opening 148 for secure mounting to an external element such as the handlebar of the same bicycle to which the associated seatpost assembly 48 or 48′ is mounted. Knob 134 is rotatable with respect to the base 132 about axis 135 and includes: notches 138 that may facilitate manual gripping and manipulation by the user's fingers; and spool 136 with groove 137 to provide position control of the control rod 82 when it is wrapped around spool 136. The groove 137 extends circumferentially and serves to provide a nest to receive the control rod 82 and includes a radial hole 141 to receive the finger 88 (shown in FIG. 3d) of the control rod 82. Knob 134 also preferably includes numbers 139 or other markings to sequentially align with registration mark 140 as a means to provide visual feedback to the user that corresponds to the rotational position of the knob 134 relative the base 132, and correspondingly to the axial position of the internal member 50 to the external member 70.

During assembly of the controller assembly 130, the control rod 82 of FIG. 3a is fed through opening 133 and into recess 146. The end of control rod 82 is then bent to provide the finger 88, with the finger 88 then inserted in hole 141as shown in FIG. 3d. The knob 134 is assembled to the base 132 in direction 149 such that the spool 136 is positioned within the recess 146 and the control rod 82 is nested in groove 137. Connector 86b is anchored in opening 133. Screw 149 is then threadably assembled to hole 143 to secure the knob 134 to the base 132. The controller assembly 130 is complete and the knob 134 may now pivot around shaft 142 in rotary directions 150a and 150b relative to base 132.

As particularly shown in FIG. 3d, the rod is positioned within groove 137 and wrapped around the spool 136 such that rotation of the knob 134 in direction 150a will provide proportional longitudinal displacement of the control rod 82 in in direction 109a. Conversely, rotation of the knob 134 in direction 150b will provide proportional longitudinal displacement of the control rod 82 in direction 109b. As such, controller assembly is bi-directional where rotation of the knob 134 in direction 150a will serve to provide axial displacement in the extending direction 17 and rotation of the knob 134 in direction 150b will serve to provide axial displacement in the retracting direction 19. The notches 138 are shown to be arranged in a circular arrangement to create a circular user interface. It is understood that this user interface may alternatively have any other desirable shape, including a lever, etc.

The user may rotationally manipulate the knob 134 such that visual alignment of numbers 139 and registration mark 140 will provide visual feedback to the user corresponding to the longitudinal displacement of the control rod 82 in directions 109a (i.e. unspooling of control rod 82) and 109b (i.e. reel-in of control rod 82). It is preferred that incrementally advancing the knob 134 in directions 150a or 150b to visually align the next number will shuttle the control rod 82 to correspondingly actuate the axial displacement to provide engagement with the next socket 73. As such, the visual alignment of a given number 139 with registration mark 140 corresponds to a given axial position of the internal member 50 that is locked by the latching mechanism. As such, it is preferred that the incremental angular spacing between sequential numbers 139 are associated with a longitudinal displacement of control rod 82 that corresponds to the incremental distance 69 of sockets. Each incremental position of the knob 134 corresponds to an incremental number 139 that also corresponds to engagement with incremental socket of the seatpost assembly 48. The controller assembly 130 is functional to allow the user to selectively manipulate and meter the longitudinal position of control rod 82 in directions 109a and 109b relative to the sheath 84 and correspondingly selectively advance the axial position of the internal member 50.

The control rod assembly 80 serves as a mechanical control link to communicate user input from the controller assembly 130 to the seatpost assembly 48, with the end portion 87a and connector 86a connected to the seatpost assembly 48 at one end of the control rod assembly 80 and with the end portion 87b, connector 86b, and finger 88 connected to the controller assembly 130 at the opposite end of the control rod assembly 80. The controller assembly 130 may then serve as a remote controller of the seatpost assembly 48 where input from the controller assembly 130 communicates to the seatpost assembly 48 through the control rod assembly 80. Longitudinal displacement of the control rod 82 within the sheath 84 serves to provide axial displacement of the cam block 92, which serves to axially displace the internal member 50 in directions 17 and/or 19.

The controller assembly 130 also serves as an actuator that is remote and external to the seatpost assembly 48, where rotation of the knob 134 serves to provide the longitudinal motion of the control rod 82, which in turn, actuates the axial displacement of the internal member 50. The controller assembly 130 also serves to transmit the motive force provided by the user to drive the internal member 50 in directions 17 and/or 19. This actuation is a “longitudinal” actuation in that actuation includes translational movement of the control rod 82 and/or the cam block 92. This is in contrast to rotational actuation, such as in U.S. Pat. No. 11,661,130, which relies on rotation of a motor. As described herein, the energy source for axial adjustment is provided by the user, who imparts motive force to the system by manually twisting the knob 134 by a predetermined amount. Correspondingly, the controller assembly 130 thereby actuates the axial displacement of the seatpost assembly 48, through the control rod assembly 80 and the aforementioned latching mechanism, to an axial position corresponding to the predetermined twist of the knob 134.

Particularly as described in FIGS. 2s-t, the control rod 82 must be driven in direction 109a to displace and push the internal member 50 in the extending direction 17, subjecting the control rod 82 to axial compressive loading. An example control rod 82 construction includes producing the control rod 82 from hardened steel wire, such as “music wire” as shown in the embodiment of FIGS. 2a-w. The control rod 82 may alternatively be any other cross section shape and/or be a stranded wire of multiple filaments and/or may be constructed from any other metallic or non-metallic material or combination of materials. Since the control rod 82 is shown here to be a rod of circular cross section of relatively small diameter 89, the rod may be considered to be a slender element that may be prone to buckling under compressive loading. In order to effectively and predictably displace and push the internal member 50 in the extending direction 17 as described, it is beneficial to reduce and mitigate this tendency for buckling, at least within the expected range of compressive loading. The tendency for compressive buckling is controlled by the “slenderness ratio”, a known engineering term, as well as the flexural modulus or Young's modulus, an intrinsic property of the material of the control rod 82. The slenderness ratio of the control rod 82 is related to its unsupported length 115 (FIG. 2s), a known engineering term, and its cross-section dimension (i.e. diameter 89). A longer unsupported length 115 and/or a narrower cross section dimension (i.e. larger slenderness ratio) corresponds to lower buckling resistance, while a shorter unsupported length 115 and/or a wider cross section dimension (i.e. smaller slenderness ratio) corresponds to increased buckling resistance. The unsupported length 115 is greatest when the seatpost assembly 48 is in the fully extended orientation shown in FIG. 2v and is smallest when in the fully retracted orientation shown in FIG. 2w.

It may be desirable that the control rod 82 be of relatively thin diameter 89 to optimize its elasticity and pliability when threaded through the sheath 84 and when wrapped around the spool 136. As such, it is preferable that the cross-sectional thickness (i.e. diameter 89) be 2.0 millimeters or less, or more preferably less than 1.0 millimeters. Further, the steel material of the rod 89 already has a relatively high flexural modulus. Therefore, it may be highly desirable to reduce the unsupported length of the control rod 82 in an effort to increase the resistance to its buckling. A method for reducing the unsupported length is to provide radial support to the control rod 82 at an axial location midway along the original unsupported length 115, thereby reducing the unsupported length. The embodiments described in FIGS. 4a-d, 5a-b, and 6a-f describe some representative arrangements that serve to provide such a method, while also accommodating the axial displacement of the internal member 50 relative to the external member 70.

FIGS. 4a-d describe a seatpost assembly 48″ comprising the seatpost assembly 48 of FIGS. 2a-w with a stack 270 incorporated therein. The stack 270 is comprised of an axial stack of three compression springs 272a-c, with spacer discs 276a and 276b inserted and axially positioned therebetween as shown.

Springs 272a-c are shown in the configuration of conventional compression springs, each having an outside diameter 274, an inside diameter 275, and a length 288 shown as a free length in FIGS. 4a-b. Spacer discs 276a-b each have a radially-extending flange 278 having a diameter dimension 284 across its radially outboard perimeter and an axial thickness 294, and axially-extending collars 280a and 280b, each having an outside diameter 282. Springs 272a-c are shown to be dimensionally identical, as is preferred, such that they have identical elastic characteristics. Spacer discs 276a-b each have a radially inboard central hole 286 extending axially therethrough that is sized to have diametral clearance with the control rod 82. The stack is arranged as shown in the figures, with collars 280a and 280b arranged to radially pilot the inside diameter 275, serving to radially center and position the springs 272a-c with their respective spacer discs 276a-b. Spacer discs 276a-b serve as spacer washers and serve to loosely maintain a laterally aligned spacing between the control rod 82 and the interior surface 91 of external member 70. With reference to the control rod 82, the term “longitudinal” references an alignment and/or direction along its length and the term “lateral” references an alignment or direction generally perpendicular to its length. As shown in these figures, the longitudinal direction of the control rod 82, within the seatpost assembly 48″, is generally parallel to and/or collinear with the axial axis 15 such that the axial and longitudinal directions are the same.

As shown in FIG. 4c, the stack 270 serves as an alignment system and is assembled within the seatpost assembly 48 and arranged so that spring 272a is axially sandwiched and braced between the underside face 65 of cap 60 and the flange 278 of spacer disc 276a and is radially piloted with collar 280a thereof. Spring 272b is axially sandwiched and braced between the flanges 278 of spacer discs 276a and 276b and radially piloted with collar 280a of spacer disc 276b and collar 280b of spacer disc 276a. Spring 272c is axially sandwiched and braced between the flange 278 of spacer disc 276b and the upper face 68 of cap 78 and is radially piloted with collar 280b of spacer disc 276b. Correspondingly, the stack is axially sandwiched and braced between the underside face 65 (connected to the internal member 50) and the face 68 (connected to the external member). FIG. 4c corresponds to the fully extended orientation of the seatpost assembly 48″, where the lengths 288′ of respective springs 272a-c are at their longest longitudinal length and the stack 270 may be considered to be in a longitudinally expanded orientation. It may be preferable that lengths 288′ be slightly shorter than (free) length 288 so that there is an initial preload of springs 272a-c.

Control rod 82 extends through the center of stack 270 such that it is threaded longitudinally through the interior (inside diameter 275) of springs 272a-c and through the holes 286 of spacer discs 276a and 276b as shown in the figures. There is a small radial clearance between the diameter 89 and the holes 286 such that the spacer discs 276a-b and springs 272a-c may be axially displaced relative to control rod 82 and vice versa without binding therebetween. Also, there is a small radial clearance between the perimeter dimensions 284 of flanges 278 and the interior surface 91 of the external member 70 such that the spacer discs 276a-b and springs 272a-c may be axially displaced relative to the external member 70 without binding therebetween. These radial clearances permit independent axial displacement between the stack 270 and both the control rod 82 and the external member 70. Stack 270 may be considered to be an alignment system in that it serves as a radial spacer to limit the radial displacement of the control rod 82 within the seatpost assembly 48″, thereby maintaining axial alignment of the control rod 82. Stack 270 is shown to be axially braced between the upper face 68 of the external member 70 and the underside face 65 of the internal member 50.

Since the radial clearance between the diameter 89 and the holes 286 is small, the control rod 82 is radially piloted within holes 286, and since the radial clearance between perimeter dimension 284 and interior dimension 98 is small, the spacer discs 276a and 276b are radially piloted and aligned within the external member 70. Thus, the control rod 82 is radially piloted within the external member 70. Since the external member 70 is a generally rigid element, the spacer discs 276a-b serve as a spacer maintain the radial spacing between the control rod 82 and external member 70 and provide radial support to the control rod 82 at the axial location of the holes 286 to correspondingly restrict radial deflection of control rod 82 at those axial locations. Correspondingly, the original unsupported length 115 of the control rod 82 is now modified to be divided into shorter (modified) unsupported lengths 296a-c as shown in FIG. 4c. In other words, with the inclusion of the stack 270, the each of the unsupported lengths 296a-c of the control rod 82 is thereby reduced to roughly ⅓ of the original unsupported length 115. By dividing the original unsupported length 115 into shorter unsupported lengths 296a-c, the original slenderness ratio of the control rod 82 is now modified to be significantly reduced and, correspondingly, its buckling resistance (i.e. ability to support compressive loading) is modified to be significantly increased such that the control rod 82 may now support much greater compressive loads, thereby greatly increasing the capacity and ability of the rod to predictably displace and push the internal member 50 in the extending direction 17 as described.

FIG. 4d corresponds to the fully retracted orientation of the seatpost assembly 48″, where the stack height 290′ is reduced and is longitudinally collapsed relative to stack height 290 of FIG. 4c. Correspondingly, the lengths 288′ of respective springs 272a-c are further compressed to their shortest lengths 288″ and the unsupported lengths 296a′-c′ are reduced. Thus, it may be seen that the stack 270 is both axially extendable and axially collapsable to passively conform to the axial space between face 68 and underside face 65 throughout the axial displacement range between the fully extended and fully retracted orientations of seatpost assembly 48″. With respect to the alignment systems described herein, the term “passive” refers to a driven or conforming response to an external driving force and/or displacement. This term in contrast to the term “active”, which is considered herein to refer to the driver that is inducing or creating a force or displacement.

It is understood that stack 270 is a schematically representative of a wide variety of alignment systems that include a longitudinally yieldable feature (i.e. springs 272a-c) and a radial or lateral alignment feature (i.e. spacer discs 276a-b). For example, an alternate stack may include any number of lateral spacer elements, such as a single spacer disc or three spacer discs, etc., that may be interposed between any number of longitudinally yieldable elements. It is further noted that the compression of springs 272a-c may be utilized to provide an axial pre-load to axially bias the internal member 50 in the axially extending direction 17 in a manner similar to spring 111 of FIG. 2x.

FIGS. 5a-b describe a seatpost assembly 48″′ comprising the seatpost assembly 48 of FIGS. 2a-w with a helical spacer 300 incorporated therein. Helical spacer 300 is incorporated within seatpost assembly 48″′ as shown in FIG. 5a and provides an alignment system that is a substitute for stack 270 of FIGS. 4a-d. The helical spacer 300 is shown in the configuration of a compression spring that is formed as a helical coil of flat material that has a width 308 and thickness 306, rather than the round wire of common compression springs. Helical spacer 300 has an outside perimeter shown as outside diameter 304, a radially inboard inside perimeter shown as inside diameter 302, and a longitudinal length 310 shown as a free length in FIGS. 5a-b.

As shown in FIGS. 5a-b, the helical spacer 300 is assembled within the seatpost assembly 48, in a manner similar to stack 270, and arranged to be axially sandwiched between the underside face 65 of cap 60 and the upper face 68 of cap 78. It may be preferable that the length 310 be somewhat longer than the axial distance between underside face 65 and upper face 68 (upon assembly and with seatpost assembly 48′″ in the fully extended orientation) such that there is an axial preload of helical spacer 300 to axially bias the internal member 50 in a manner similar to spring 111 of FIG. 2x.

Control rod 82 extends through the helical spacer 300 such that it is threaded through the inside diameter 302 of as shown, including a radial clearance between the diameter 89 and the inside diameter 302. The helical spacer 300 is shown to be wrapped around the control rod 82 in a loose helical embrace such that the helical spacer 300 may be smoothly axially displaced relative to control rod 82 and vice versa without binding therebetween. Also, there is a small radial clearance between the outside diameter 304 and the interior surface 91 of the external member 70 such that the helical spacer 300 may be axially displaced relative to the external member 70 and vice versa without binding therebetween. It may be considered that the interior surface 91 serves as a radial guide to maintain the axial alignment of the outside diameter 304. Due to the width 308, the inside diameter 302 thereby serves to maintain axial alignment of the rod 82 therethrough. As such, the helical spacer 300 serves as a radial spacer between the interior surface 91 and the rod 82 to maintain axial alignment of the rod 82 and to reduce any tendency of its buckling. Meanwhile, the helical spacer 300 is also axially collapsable to serve this spacer function while also following the axial displacement of the internal member 50 relative the external member 70. Helical spacer 300 may be considered to be an alignment system in that it serves as a radial spacer to limit the radial displacement of the control rod 82 and is shown to be axially braced between the upper face 68 of the external member 70 and the underside face 65 of the internal member 50.

Since the radial clearance between the diameter 89 and the inside diameter 302 is small, the control rod 82 is radially piloted within inside diameter 302, and since the radial clearance between outside diameter 304 and interior surface 91 is small, the helical spacer 300 is radially piloted within the external member 70. Thus, the control rod 82 is radially piloted within the external member 70, with the helical spacer 300 serving a similar alignment function to spacer discs 276a-b of FIGS. 4a-d. Since the external member is radially rigid, the helical spacer 300 serves as a spacer maintain the lateral and radial spacing between the control rod 82 and external member 70 and provide radial support to the control rod 82 to correspondingly restrict radial deflection of control rod 82.

Correspondingly, the original unsupported length 115 (shown in FIGS. 4a-d) of the control rod 82 is now modified and divided into shorter unsupported lengths corresponding to the helical pitch 312 of the helical spacer 300. In other words, with the incorporation of the helical spacer 300 within the seatpost assembly 48″, the original unsupported length 115 is now roughly divided by the number of helical turns of the helical spacer 300. By dividing the original unsupported length 115 into these shorter modified unsupported lengths (corresponding to pitch 312), the original slenderness ratio (corresponding to unsupported length 115) of the control rod 82 is modified to be increased and, correspondingly, the buckling resistance (i.e. ability to support compressive loading without buckling or adverse lateral distortion) of the control rod 82 is modified to be significantly increased such that the control rod 82 may now support much greater compressive loads, thereby greatly increasing the ability of the rod to predictably displace and push the internal member 50 in the extending direction 17 as described. Since the helical pitch 312 is shown to be even shorter than the unsupported lengths 296a-c of FIG. 4c, the buckling resistance provided by the helical spacer 300 is even greater than that of the stack 270.

Like conventional compression springs, helical spacer 300 is an axially elastic element that is both longitudinally expandable and longitudinally collapsable to passively conform to the axial space between face 68 and underside face 65 throughout the axial displacement range between the fully extended and fully retracted orientations of seatpost assembly 48′ “. It is further noted that the elastic axial compression of helical spacer 300 may be utilized to provide an axial pre-load to bias the internal member in a manner similar to spring 111 of FIG. 2x. It is preferable that the axial deflection of helical spacer 300 be maintained within its elastic limit so that it does not experience permanent deformation during operation of the seatpost assembly 48”.

Helical spacer 300 may be made of a variety of materials, including metallic materials such as steel or aluminum or polymeric materials such as nylon. Further, the helical spacer 300 may additionally include geometry to more closely interface with the underside face 65 and/or face 68 for improved alignment between the helical spacer and the internal member 50 and/or external member 70. Furthermore, while helical spacer 300 is shown to have a left-hand or counterclockwise helical form, it is possible to alternatively have a clockwise helical form. It may alternatively be preferable to substitute a helical spacer that has both clockwise and counterclockwise helical forms that are axially stacked on each other. Such an arrangement is shown in FIG. 5c, where the helical spacer 314 has a clockwise helical form 316a axially stacked on a counter clockwise helical form 316b. Helical forms 316a and 316b may be discrete helical forms or they may be integral and monolithic with each other as shown in FIG. 5c where helical forms 316a and 316b are integrally joined to each other at location 318.

The embodiment described in FIGS. 5d-f describe a less schematic and more detailed version of the embodiment of FIG. 5c. As shown in FIGS. 5d-f, the helical spacer 350 may be substituted for the helical spacer 300 in the seatpost assembly 48″ ″. Helical spacer 350 is shown in the configuration of a compression spring that is formed from a clockwise helical form 352 of clockwise helical coils 356 that is longitudinally stacked on a counterclockwise helical form 354 of counterclockwise helical coils 358. Helical spacer 350 has a radially outboard outside perimeter shown as outside diameter 360, a radially inboard inside perimeter shown as inside diameter 362, and a longitudinal length 364 shown as a free length in FIGS. 5a-b. Spacer disc 366 is longitudinally positioned between the clockwise helical form 352 and counterclockwise helical form 354. Also included is a first end portion 368 to interface with the underside face 65 and a second end portion 370 to interface with the face 68. Spacer disc 366, first end portion 368, and second end portion 370 each include an outside diameter roughly corresponding to outside diameter 360 and respective central openings 372a-c to allow control rod 82 to extend therethrough. FIGS. 5d-e show the helical spacer 350 to have a longitudinal length 360 in its longitudinally expanded free state, while FIG. 5f show the helical spacer 350 as longitudinally compressed from its free state to a longitudinal length 360′.

Clockwise helical coils 356 and counterclockwise helical coils 358 are shown to have an axially thickened rim 374 radially adjacent to the outside diameter 360, which may promote consistency of the outside diameter 360 of the helical forms 352 and 354 as the helical spacer is longitudinally compressed. Like the helical spacer 300, helical spacer 350 serves as a spacer maintain the lateral and radial spacing between the control rod 82 and external member 70 and provide radial support to the control rod 82 to correspondingly restrict radial deflection and buckling of control rod 82. By including both a clockwise helical form 316a and a counter clockwise helical form 316b, this will reduce the tendency of the first end portion 368 to circumferentially twist relative to the second end portion 370 as the helical spacer is longitudinally compressed.

FIGS. 6a-f describe a seatpost assembly 48“ ” comprising the seatpost assembly 48 of FIGS. 2a-w with a bellows 320 incorporated therein. Bellows 320 is incorporated within seatpost assembly 48″″ as shown in FIG. 6a and provides an alignment system that is a substitute for stack 270 of FIGS. 4a-d. The bellows 320 has the general schematic configuration of a bellows known in industry and includes convolutions, shown here as a plurality of axially stacked segments 338 having inner rings 336 at their roots with hole 342 therethrough, outer rings 334 at their crests, and with diaphragms 332a-b extending therebetween as shown. As an enhancement to conventional bellows, it may be preferable to provide thickened inner rings 336 and thickened outer rings 334 in comparison to the thickness of the diaphragm, as shown in FIGS. 6a-f, so that their radial dimensions are less prone to shrink or expand as the bellows 320 is axially deflected. Further, it may be preferable to include circumferential corrugations 340a-b in the respective diaphragms 332a-b to allow the diaphragms to passively and elastically collapse in the lateral direction as the bellows 320 is axially and/or longitudinally compressed to minimize the radial stress imparted on the inner rings 336 and outer rings 334, and correspondingly, to minimize the lateral shrinkage deflection of inside diameter 322 of inner rings 336 and/or lateral expansion deflection of outside diameter 324 of outer rings 334 as the bellows 320 is axially deflected. Such corrugation of diaphragms is well known in industry.

Bellows 320 has a laterally inboard inside perimeter shown as inside diameter 322 (at inner ring 336) and a laterally outboard outside perimeter shown as outside diameter 324 (at outer ring 334) and a free length 330 in FIG. 6a between end faces 344a and 344b. As shown in FIG. 6b, the bellows 320 is assembled and incorporated within the seatpost assembly 48″ ″′ and arranged to be axially sandwiched between the underside face 65 of cap 60 and the upper face 68 of cap 78, with end face 344a axially abutting underside face 65 and end face 344b axially abutting face 68. The seatpost assembly 48“ ” is shown in FIG. 6b to be fully extended, with the bellows 320 in the longitudinally expanded orientation. It may be preferable that the length 330 be somewhat longer than the axial distance between underside face 65 and upper face 68 (upon assembly, and with seatpost assembly 48″ in the fully extended orientation) such that there is an axial preload of bellows 320.

Control rod 82 extends through the bellows 320 such that it is threaded through the inside diameter 322 of each inner ring 336 as shown. There is a radial clearance between the diameter 89 and the inside diameter 322 such that bellows 320 may be axially displaced relative to control rod 82 and vice versa without binding therebetween. Also, there is a small radial clearance between the outside diameter 324 and the interior surface 91 of the external member 70 such that the bellows 320 may be axially and longitudinally displaced relative to the external member 70 and vice versa without binding therebetween. Bellows 320 may be considered to be an alignment system in that it serves as a lateral spacer to limit the lateral displacement of the control rod 82 and is shown to be axially braced between the upper face 68 of the external member 70 and the underside face 65 of the internal member 50.

Since the radial clearance between the diameter 89 and the inside diameter 322 is small, the control rod 82 is radially piloted within inside diameter 322, and since the radial clearance between outside diameter 324 and interior surface 91, the bellows 320 is radially piloted within the external member 70. Thus, the control rod 82 is radially piloted within the external member 70, with the bellows 320 serving a similar alignment function to spacer discs 276a-b of FIGS. 4a-d. Since the external member 70 is radially and laterally rigid, the bellows 320 serves as a spacer to maintain the lateral spacing between the control rod 82 and external member 70 and provide radial support to the control rod 82 to correspondingly restrict radial deflection of control rod 82.

FIGS. 6a, 6c, and 6d show the bellows 320 in their free state having a length 330 prior to assembly within the seatpost assembly 48″ ″. FIG. 6b shows the bellows as slightly axially and elastically compressed and deflected to length 330′, with the seatpost assembly 48“ ” in the fully extended orientation. FIGS. 6e-f show the bellows 320 as elastically deflected to a longitudinally collapsed orientation where the bellows 320 is deflected to length 330″, which corresponds to the axial distance between the underside face 65 of cap 60 and the upper face 68 when the seatpost assembly 48″ is in the fully retracted orientation. Note that the aforementioned corrugations are correspondingly further deflected as compared to those shown in FIGS. 6a-d.

Correspondingly, the original unsupported length 115 of the control rod 82 is now modified to be divided into shorter (modified) unsupported lengths corresponding to the axial segment length 328 of each segment 326. In other words, with the inclusion of the bellows 320, the original unsupported length 115 is now roughly divided by the number of segments 326. By dividing the original unsupported length 115 into these shorter unsupported segment lengths 328, the original slenderness ratio is modified to be decreased, and correspondingly, the buckling resistance (i.e. ability to support compressive loading) of the control rod 82 is modified to be significantly increased such that the control rod 82 may now support much greater compressive loads, thereby greatly increasing the ability of the control rod 82 to be predictably longitudinally displaced and to axially push the internal member 50 in the extending direction 17 as described. Since the segment length 328 is shown to be significantly shorter than the unsupported lengths 296a-c of FIG. 4c, the buckling resistance provided by the bellows 320 is even greater than that of the stack 270.

Like conventional bellows, the bellows 320 is an axially elastic element that is both axially expandable and axially collapsable to passively conform to the axial space between face 68 and underside face 65 throughout the axial displacement range between the fully extended and fully retracted orientations of seatpost assembly 48″ ″. It is further noted that the elastic axial compression of bellows 320 may be utilized to provide an axial pre-load to bias the internal member in a manner similar to spring 111 of FIG. 2x. It is preferable that the axial deflection of bellows 320 be maintained within its elastic limit so that it does not experience permanent deformation during operation.

Bellows 320 may be made of a variety of materials, including metallic materials or polymeric materials or, more preferably, elastomeric materials. Further, the bellows 320 may additionally include geometry to more closely interface with the underside face 65 and/or face 68 for improved alignment between the helical spacer and the internal member 50 and/or external member 70.

While my above description contains many specificities, these should not be construed as limitations on the scope of the invention, but as merely providing exemplary illustrations of some of the preferred embodiments of this invention. For example:

The present invention comprises a seatpost assembly having a second portion (i.e. internal member 50) to which a seat may be mounted and a first portion (i.e. external member 70) that is fixed to a frame. The first and second portions may be arranged to be displaced relative to each other in generally parallel movement to adjust the height of the seat relative to the frame between an extended and raised position and a retracted and lowered position of the seat. This parallel movement is manifest as telescopic displacement in the embodiments of the present invention described herein. However, such parallel displacement may be achieved without a telescopic arrangement. For example, parallel displacement may be achieved by a 4-bar parallelogram linkage, including idler links between the first and second portions.

While the embodiments of FIGS. 2a-w and 3a-d describe respective wrapped spool 136 to drive and/or control axial displacement of the control rod, a wide range of alternative mechanisms known in industry may alternatively be substituted for this purpose. For example, a rack-and-pinion mechanism may be incorporated into the controller and/or actuator to drive and/or control axial displacement. In one such an arrangement, the user may manipulate the pinion gear to longitudinally drive the rack gear with the control rod 82 affixed thereto.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A seatpost assembly comprising:
a first seatpost portion;
a second seatpost portion that is axially displaceable relative to said first seatpost portion along an axial axis in an axially retracting direction of increasing axial overlap with said first seatpost portion to a first axial position; and in an axially extending direction of decreasing axial overlap with said first seatpost portion to a second axial position that is axially extended relative to said first axial position;
a motive force to drive said axial displacement;
a control rod to transmit said motive force;
wherein said second seatpost portion is configured to include a seating surface;
wherein said motive force is an active motive force applied to drive said second seatpost portion in at least one of said extending direction and said retracting direction;
wherein said motive force is actuated remotely from said seatpost assembly.

2. The seatpost assembly according to claim 1, including a sheath, wherein said control rod transmits said motive force within said sheath.

3. The seatpost assembly according to claim 1, wherein said control rod may be displaced in a first longitudinal direction to push said second seatpost portion in said extending direction.

4. The seatpost assembly according to claim, wherein said control rod may be displaced in a second longitudinal direction opposed to said first longitudinal direction to pull said second seatpost portion in said retracting direction.

5. The seatpost assembly according to claim, wherein said displacement in said first longitudinal direction serves to apply a longitudinal compressive load to said control rod, including an original unsupported longitudinal length and a corresponding original slenderness ratio of said control rod, further including an alignment system that is functional to laterally support said control rod by limiting and/or restraining the lateral displacement of said control rod at a location within said original unsupported longitudinal length to provide a modified unsupported longitudinal length of said control rod therein that is shorter than said original unsupported longitudinal length and corresponding to a modified slenderness ratio that is less than said original slenderness ratio such that the inclusion of said alignment system serves to reduce the propensity for compressive buckling due to said longitudinal compressive load of said control rod due to said longitudinal compressive load within said original unsupported longitudinal length.

6. The seatpost assembly according to claim, wherein the cross-sectional thickness of said control rod is less than or equal to 2.0 millimeters within said modified unsupported longitudinal length.

7. The seatpost assembly according to claim, wherein the cross-sectional thickness of said control rod is less than or equal to 1.0 millimeters within said modified unsupported longitudinal length.

8. The seatpost assembly according to claim, wherein said alignment system is axially extendable and axially collapsable between a longitudinally expanded orientation and a longitudinally collapsed orientation.

9. The seatpost assembly according to claim, wherein said alignment system includes an elastic member that may be axially displaced within the elastic range of said elastic member.

10. The seatpost assembly according to claim, wherein said elastic member includes a compression spring to provide elastic bias of said alignment system.

11. The seatpost assembly according to claim, wherein said elastic member is passively driven by said axial displacement of said second seatpost portion.

12. The seatpost assembly according to claim, wherein said alignment system serves to axially bias said second seatpost portion in said axially extending direction.

13. The seatpost assembly according to claim, wherein said alignment system is axially braced between said first seatpost portion and said second seatpost portion.

14. The seatpost assembly according to claim, wherein said alignment system includes a radially inboard opening therethrough and a radially outboard perimeter, wherein said control rod is radially piloted within said radially inboard opening and said radially outboard perimeter is radially piloted by at least one of said first seatpost portion and said second seatpost portion.

15. The seatpost assembly according to claim, wherein said radially inboard opening has radial clearance with said control rod to permit independent axial displacement therebetween.

16. The seatpost assembly according to claim, wherein said radially outboard perimeter has radial clearance with at least one of said first seatpost portion and said second seatpost portion to permit independent axial displacement between said alignment system and said at least one of said first seatpost portion and said second seatpost portion.

17. The seatpost assembly according to claim, wherein said alignment system includes a spacer washer having a spacer inside diameter and a spacer outside perimeter thereof, wherein said control rod is piloted within said spacer inside diameter and said spacer outside perimeter is piloted by at least one of said first seatpost portion and said second seatpost portion.

18. The seatpost assembly according to claim, wherein said alignment system includes a helical spacer having a radially inboard helical spacer inside perimeter and a radially outboard helical spacer outside perimeter, wherein said control rod is piloted within said helical spacer inside perimeter and said helical spacer outside perimeter is piloted by at least one of said first seatpost portion and said second seatpost portion.

19. The seatpost assembly according to claim, wherein said helical spacer includes a clockwise helical form and a counterclockwise helical form.

20. The seatpost assembly according to claim, wherein said alignment system includes an elastic bellows having a radially inboard bellows inside perimeter and a radially outboard bellows outside perimeter, wherein said control rod is piloted within said inside perimeter and said outside perimeter is piloted within at least one of said first seatpost portion and said second seatpost portion.

21. The seatpost assembly according to claim, wherein said alignment system is axially extendable and axially collapsable between an axially expanded orientation and an axially collapsed orientation, wherein said bellows includes diaphragm portions thereof and wherein said diaphragm portions include elastic corrugations such that said diaphragm portions may be passively radially collapsed due to axial deflection between said axially expanded orientation and said axially collapsed orientation to maintain said bellows inside perimeter and said bellows outside perimeter.
